(19) United States
(12) Patent Application Publication
(10) Pub. No.: US 2026/0155124 A1
(43) Pub. Date: Jun. 4, 2026

(54) INFORMATION PROCESSING APPARATUS, INFORMATION PROCESSING METHOD, AND INFORMATION PROCESSING PROGRAM

(71) Applicant: Sony Group Corporation, Tokyo (JP)

(72) Inventors: Shintaro MASUI, Tokyo (JP); Yoshiya ASAUMI, Tokyo (JP)

(73) Assignee: Sony Group Corporation, Tokyo (JP)

(21) Appl. No.: 18/685,898

(22) PCT Filed: Mar. 7, 2022
(86) PCT No.: PCT/JP2022/009615

§ 371 Date: Feb. 23, 2024

(30) Foreign Application Priority Data
Sep. 6, 2021 (JP) 2021-144665

(51) Int. Cl. G10H 1/00

(52) U.S. Cl. CPC G10H 1/0025; G10H 2210/056; G10H 2210/105

(57) ABSTRACT

An information processing apparatus includes: an acquisition unit that acquires first content; a reception unit that receives, from a user, a request for separating the first content acquired by the acquisition unit into a plurality of sound sources; and a generation unit that generates the sound sources separated from the first content in a format that can be used on a digital audio workstation (DAW) by inputting the first content to a model in which a feature of each sound source constituting music is learned in advance on the basis of the request received by the reception unit.

### FIELD

The present disclosure relates to an information processing apparatus, an information processing method, and an information processing program related to music production.

### BACKGROUND

In recent years, with the spread of composition tools such as the Internet and a digital audio workstation (DAW), the number of creators who perform composition to distribution by themselves has increased. For example, in the fields of dance music and hip hop music, many secondary creation contents are produced, such as sampling existing music and creating new music.

Regarding sampling of music, there is known a technique of analyzing existing music using a model learned by a neural network and separating a sound source for each part of a musical instrument or the like constituting the music, such as vocals or drums (for example, Patent Literature 1).

### CITATION LIST

### Patent Literature

Patent Literature 1: WO 2018/047643 A

### SUMMARY

### Technical Problem

The related art is useful for music production, for example, in that it is possible to extract only a sound source of a musical instrument necessary for music to be used for sampling by a creator.

Meanwhile, when handling the sound source extracted by the creator, complicated labor occurs. For example, the creator needs to take the extracted sound source into the DAW, manage the copyright information related to each extracted sound source, and manually input the copyright information related to the music produced by the creator. Such work may hinder smooth music production.

Therefore, the present disclosure proposes an information processing apparatus, an information processing method, and an information processing program capable of efficiently producing and managing music.

### Solution to Problem

In order to solve the above problems, an information processing apparatus according to an embodiment of the present disclosure includes: an acquisition unit that acquires first content; a reception unit that receives, from a user, a request for separating the first content acquired by the acquisition unit into a plurality of sound sources; and a generation unit that generates the sound sources separated from the first content in a format that can be used on a digital audio workstation (DAW) by inputting the first content to a model in which a feature of each sound source constituting music is learned in advance on the basis of the request received by the reception unit.

### BRIEF DESCRIPTION OF DRAWINGS

FIG. 1 is a diagram (1) illustrating an outline of an information processing system according to an embodiment.

FIG. 2 is a diagram (2) illustrating an outline of an information processing system according to an embodiment.

FIG. 3 is a diagram illustrating an outline of sound source separation processing according to an embodiment.

FIG. 4 is a diagram (1) illustrating a user interface according to an embodiment.

FIG. 5 is a diagram (2) illustrating a user interface according to an embodiment.

FIG. 6 is a diagram (3) illustrating a user interface according to an embodiment.

FIG. 7 is a diagram (4) illustrating a user interface according to an embodiment.

FIG. 8 is a diagram (5) illustrating a user interface according to an embodiment.

FIG. 9 is a diagram (6) illustrating a user interface according to an embodiment.

FIG. 10 is a diagram (7) illustrating a user interface according to an embodiment.

FIG. 11 is a diagram (8) illustrating a user interface according to an embodiment.

FIG. 12 is a diagram (9) illustrating a user interface according to an embodiment.

FIG. 13 is a diagram (10) illustrating a user interface according to an embodiment.

FIG. 14 is a diagram illustrating a configuration example of an information processing apparatus according to an embodiment.

FIG. 15 is a diagram illustrating an example of a creator storage unit according to an embodiment.

FIG. 16 is a diagram illustrating an example of a sound source storage unit according to an embodiment.

FIG. 17 is a diagram illustrating a concept of music data according to an embodiment.

FIG. 18 is a flowchart (1) illustrating a procedure of information processing according to an embodiment.

FIG. 19 is a flowchart (2) illustrating a procedure of information processing according to an embodiment.

FIG. 20 is a sequence diagram illustrating a procedure of an information processing system according to an embodiment.

FIG. 21 is a hardware configuration diagram illustrating an example of a computer that implements functions of an information processing apparatus.

### DESCRIPTION OF EMBODIMENTS

Hereinafter, embodiments of the present disclosure will be described in detail with reference to the drawings. Note that, in each of the following embodiments, the same parts are denoted by the same reference signs, and redundant description will be omitted.

The present disclosure will be described according to the following order of items.
1. Embodiments
1-1. Example of Information Processing System According to Embodiment
1-2. Example of Sound Source Separation Processing According to Embodiment
1-3. Example of Right Information Assignment According to Embodiment
1-4. Configuration of Information Processing Apparatus According to Embodiment
1-5. Procedure of Information Processing According to Embodiment
1-6. Modifications of Embodiments
1-6-1. Operation as Information Processing System
1-6-2. Right Information
1-6-3. Production System
2. Other Embodiments
3. Effects of Information Processing Apparatus According to Present Disclosure
4. Hardware Configuration

### 1. Embodiments

### 1-1. Example of Information Processing System According to Embodiment

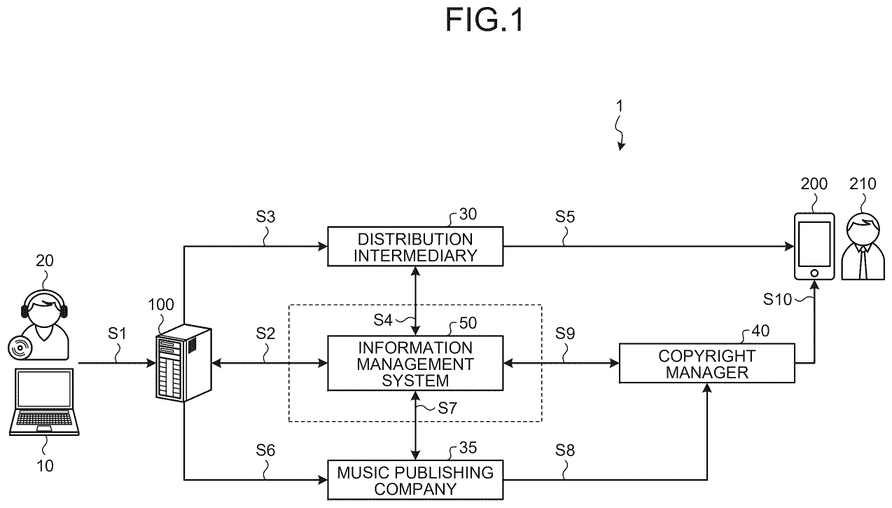

FIG. 1 is a diagram illustrating an outline of an information processing system 1 according to an embodiment. FIG. 1 is a schematic block diagram illustrating elements (apparatuses and the like) constituting the information processing system 1 and processing executed in the information processing system 1. The information processing system 1 executes various types of information processing related to a digital audio workstation (DAW) provided by an information processing apparatus 100 to a creator 20.

As illustrated in FIG. 1, the information processing system 1 includes a creator terminal 10, a distribution intermediary 30, a music publishing company 35, a copyright manager 40, an information management system 50, an information processing apparatus 100, and a user terminal 200. These various apparatuses are communicably connected in a wired or wireless manner via a network N (for example, the Internet) (not illustrated).

The creator terminal 10 is a terminal apparatus used by the creator 20 who produces music on the DAW provided by the information processing apparatus 100. For example, the creator terminal 10 is a personal computer (PC), a smartphone, a tablet terminal, or the like. Note that the creator 20 is not limited to the composer of the music, and may include a person having any right related to the music, such as a lyricist or an arranger. Furthermore, in the description of the present disclosure, the term DAW is used as a program used for music production, but the technology of the present disclosure is not necessarily limited thereto. The DAW in the present disclosure broadly refers to general software and applications used for music production and the like in various devices including a smartphone, a PC, and the like, and is a concept including software and the like not referred to as a so-called DAW.

In the embodiments, the content to be produced is referred to as “music”, but the content is not limited to music, and may be video content such as a movie. Furthermore, the content may be not only completed content such as music, but also some sound sources used for music, short sound used for sampling, and the like. Note that the sound source according to the embodiments is sound data that is an element constituting music, and includes various types of information. For example, the sound source includes data such as a tone, a height, and a speed (tempo) of sound, and is recorded in a recording medium in various file formats in which information processing is possible. On a DAW, sound sources are generally represented in a waveform manner. A material of music distributed in a music distribution site, a moving image distribution site, or the like is also an aspect of the sound source. Furthermore, the sound sources can be separated using, for example, the existing technology described in the prior art or the like. As an example, sound sources that include a plurality of musical instruments are separable into sound sources for each individual musical instrument.

The distribution intermediary 30 indicates a mediator (generally referred to as a distributer or the like) that mediates the distribution of the music produced on the DAW, and a server or a terminal apparatus used by the mediator. For example, the distribution intermediary is a company that operates a music sales site or a moving image distribution site or supplies content to these sites.

The music publishing company 35 indicates a business operator that performs business such as copyright management and promotion of music produced by the creator 20, and a server or a terminal apparatus used by the business operator.

The copyright manager 40 indicates an organization that manages the copyright registered from the music publishing company 35 in the country, and a server or a terminal apparatus used by the organization. The copyright manager 40 performs processing such as calculation of a copyright usage fee when music is used, collection of the copyright usage fee, distribution of the copyright usage fee to the music publishing company 35, and the like, for example.

The information management system 50 is a system that records various kinds of information related to music. For example, the information management system 50 is a distributed ledger system called a blockchain in which data is shared by a plurality of nodes. For example, the information management system 50 is a consortium-type blockchain in which each of the information processing apparatus 100, the distribution intermediary 30, the music publishing company 35, and the copyright manager 40 is a node. Note that each person (generally referred to as an “entity” or the like) constituting the information processing system 1 enjoys a messaging service that exchanges messages and the like via a network.

The information processing apparatus 100 is an apparatus that executes information processing according to the present disclosure, and is, for example, a cloud server connected to the creator terminal 10 via the Internet. The information processing apparatus 100 provides the creator 20 with the DAW that operates on the creator terminal 10. Furthermore, the information processing apparatus 100 may play a role as a so-called music label that manages music produced by the creator 20.

The user terminal 200 is a terminal apparatus used by an user 210, and is, for example, a PC, a smartphone, a tablet terminal, or the like. In accordance with the operation of the user 210, the user terminal 200 accesses a music distribution site, a moving image distribution site, or the like to which music is provided via the distribution intermediary 30, acquires music from the site, and reproduces the acquired music.

Note that, in FIG. 1, each element constituting the information processing system 1 conceptually indicates a function in the information processing system 1, and can take various modes depending on the embodiment. For example, each element constituting the information processing system 1 may be one or two or more terminal apparatuses. Furthermore, each element constituting the information processing system 1 may be a terminal apparatus operated artificially or a program operated in the terminal apparatus.

In the example illustrated in FIG. 1, the creator 20 operates the DAW provided by the information processing apparatus 100 on the creator terminal 10 to produce music. Conventionally, various complicated processes have been required to distribute music produced by the creator 20. For example, in producing music, the creator 20 accesses a material providing site that provides a music material and purchases a material to be used for the music. Alternatively, the creator 20 extracts a part of existing music or filters music by frequency, and processes the existing music to create a material. Copyright information is set in such a material, and the creator 20 needs to apply to the material providing site, the right holder, or the like for the time used for the music, the part used, or the like. Furthermore, in a case where a part of the sound source is extracted from a material using a predetermined filter, the creator 20 needs to convert the sound source into a format that can be used in the DAW and check whether or not the extracted sound source can be used for the music according to the rules. In addition, in a case where the creator 20 desires to change the speed (tempo) or the pitch (key) of the material, it takes time and effort to download the material from the material providing site or the like to the creator terminal 10 and edit the material with the DAW.

Furthermore, in a case where the creator 20 desires to distribute the music after producing the music, it is necessary to apply for all the materials used for the music for the right processing. At this time, the creator 20 needs to record a part where the material is used in the music, a use time, right holder information of each material, and the like. Since such work is manually performed by the creator 20, it takes time and effort, and recording errors and the like are likely to occur. That is, conventional music production has many problems for efficiently producing and managing music.

Therefore, the information processing system 1 and the information processing apparatus 100 according to the present disclosure solve the above problems by the following information processing. Specifically, the information processing apparatus 100 provides the creator 20 with a DAW in which functions such as processing of separating a sound source from a material and right processing of produced music are integrated. As a result, the creator 20 can efficiently produce music, and can collectively perform right processing required at the time of distribution, a distribution procedure of a copyright usage fee when own music is used, and the like. Furthermore, according to the DAW and the database provided by the information processing apparatus 100, in a case where the own music or material is used, another creator providing the existing music can appropriately collect the copyright usage fee corresponding to the use.

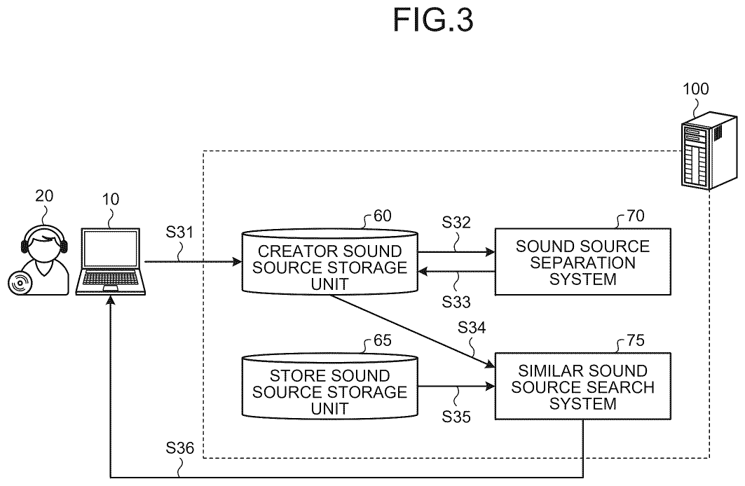

Hereinafter, information processing by the information processing system 1 will be described along a flow with reference to FIG. 1. First, the creator 20 produces music on the creator terminal 10 using the DAW which is a cloud application provided from the information processing apparatus 100. The information processing apparatus 100 executes the sound source separation processing according to the present disclosure on the creator terminal 10 via the DAW in the process of music production. Furthermore, the information processing apparatus 100 assigns copyright information or the like to music on the basis of the material or the like used by the creator 20. The processing on the DAW will be described in detail below with reference to FIG. 3.

Thereafter, the creator 20 registers the produced music and the right information related to the music in the information processing apparatus 100 (Step S1). The information processing apparatus 100 registers various kinds of information such as music, right information regarding the music, and contract information with the creator 20 in the information management system 50 (Step S2).

Note that, in a case where the creator 20 uses existing music, a material distributed in a material distribution site, or the like for production, permission by the right holder of the original music (material) is required for the use. In this case, the information processing apparatus 100 accesses the information management system 50, and acquires the right information registered by the right holder of the original music. Then, the information processing apparatus 100 refers to the right information, and presents conditions (copyright usage fee, usage permission time, and the like) in a case where existing music and materials are used to the creator 20. As will be described later, since these pieces of right information are recorded in advance in the information processing apparatus 100 or the information management system 50, the creator 20 can use these materials by applying to the effect that it is desired to use them on the DAW. Note that, in a case where rights of a plurality of persons are related to the music produced by the creator 20, the information processing apparatus 100 acquires the right information from all right related persons. For example, the information processing apparatus 100 can contact the right holders by messaging or the like on the DAW, perform agreement processing of a contract for use in music, and acquire the right information from a plurality of persons. This is because the metadata of the music produced by the creator 20 includes the identification information registered for each material, the identification information of the copyright holder, and the like, and the information processing apparatus 100 can specify the copyright holder.

The information management system 50 manages music information using a blockchain. For example, the information management system 50 writes various procedures and information related to rights such as conditions in a case where a third party uses music, a usage contract, and calculation of a distribution amount in a program (referred to as a smart contract) executed in a blockchain. That is, since the creator 20 can register the music produced by the creator in the tamper-proof blockchain, it is possible to reliably prove that the music is the work of the creator.

Furthermore, when receiving the registration of the music, the information processing apparatus 100 transmits information regarding the music to the distribution intermediary 30 (Step S3). In other words, the information processing apparatus 100 entrusts the distribution intermediary 30 with the sound source and the distribution processing of the music as a music label. The distribution intermediary 30 accesses the information management system 50 and acquires the right information to be noted when the music is distributed (Step S4). In addition, the distribution intermediary 30 writes, in the information management system 50, conditions such as a distribution amount in a case where the music is reproduced on a music distribution site or the like. Thereafter, the distribution intermediary 30 provides the music to the user 210 via a music distribution site, a moving image distribution site, or the like (Step S5).

Note that the information processing apparatus 100 may present the distribution condition by the distribution intermediary 30 to the creator 20 at the timing of Step S4. For example, on the DAW, the information processing apparatus 100 presents, to the creator 20, the amount of distribution per song on a predetermined site, the distribution amount or revenue per reproduction, the share of copyright usage fee at that time, and the like. The creator 20 may determine whether or not to entrust the distribution to the distribution intermediary 30 after confirming the information. In a case where it is determined to entrust the distribution, the distribution intermediary 30 or the information processing apparatus 100 writes the information in the information management system 50. By writing this contract information on the blockchain, the creator 20 can prevent the contract content from being tampered without permission or the like. In addition, the creator 20 can simultaneously check the distribution conditions on the DAW that registers the music and applies for distribution. The information processing apparatus 100 can support the production activity of the creator 20 by providing the creator 20 with the DAW that can integrally manage the music production to the distribution.

Upon receiving the registration of the music, the information processing apparatus 100 transmits the copyright information related to the music to the music publishing company 35 (Step S6). In other words, the information processing apparatus 100 transfers the copyright related to the music to the music publishing company 35. Then, the music publishing company 35 writes information regarding the transferred copyright in the information management system 50 (Step S7). For example, the music publishing company 35 writes, in the information management system 50, information such as what kind of copyright holder is set for the music and what kind of share is obtained in a case where the distribution amount is obtained from the copyright manager 40. In addition, the music publishing company 35 applies for the copyright information to the copyright manager 40, which is a predetermined association that manages a copyright, on the basis of laws and regulations of each country (Step S8). Normally, in a case where the music publishing company 35 or the like applies for the copyright information to the copyright manager 40, it is necessary to handwrite the information in a procedure document or the like, and there is a possibility that human cost is required, it takes time to complete the application, or omission occurs. On the other hand, in the information processing according to the embodiment, by using the copyright information automatically assigned to the music by the DAW in advance, it is possible to reduce the labor required for the processing and to prevent erroneous information from being registered.

The copyright manager 40 writes the copyright information acquired from the music publishing company 35 in the information management system 50 (Step S9). For example, the copyright manager 40 writes a copyright amount or the like to be paid to the copyright manager 40 in a case where the music is viewed or publicly transmitted, such as a scene or a condition in which the music can be used. In this manner, each person constituting the information processing system 1 manages and updates the information on the blockchain, thereby constructing information regarding music that cannot be tampered with and can be traced. Furthermore, the copyright manager 40 provides the user 210 with information such as conditions in a case where the user 210 uses music via a predetermined site or the like (Step S10). In other words, the copyright manager 40 gives a use permission in a case where music is used to a music distribution site or the like accessed by the user 210.

Through these processes, the user 210 can view the music produced by the creator 20.

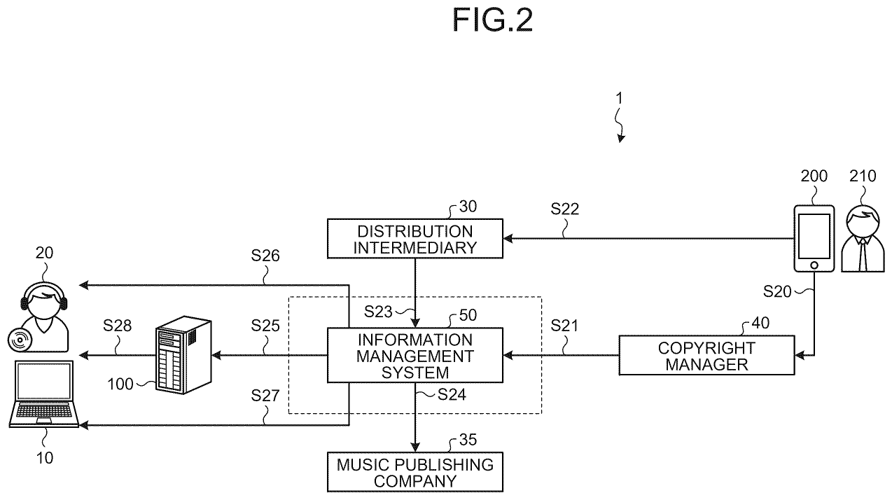

Next, a flow of usage fee processing and the like in a case where music produced by the creator 20 is used will be described with reference to FIG. 2. FIG. 2 is a diagram (2) illustrating an outline of the information processing system 1 according to the embodiment.

In FIG. 2, in a case where the user 210 uses music, information indicating that the music has been used is transmitted from the user terminal 200 to a music distribution site or the like. The music distribution site or the like pays the copyright manager 40 a usage report and a copyright usage fee regarding the music (Step S20). The copyright manager 40 registers the usage report received from the music distribution site or the like and the information regarding the collected copyright usage fee in the information management system 50 (Step S21).

Furthermore, the music distribution site or the like pays a distribution report such as the number of times and time of distributing the music and the master disk usage fee to the distribution intermediary 30 (Step S22). The distribution intermediary 30 registers, in the information management system 50, the distribution report received from the music distribution site or the like and the information regarding the collected master disk usage fee (Step S23).

The information management system 50 redistributes the collected copyright usage fee to the music publishing company 35 on the basis of the copyright information set in the music (Step S24). Furthermore, the information management system 50 reports to the music publishing company 35 indicating the content in which the music is used. Note that such processing may be performed by a manager of the information management system 50 (for example, a manager of the information processing apparatus 100), or may be performed according to a program described in advance as a smart contract. For example, in a case where there is a copyright usage fee or a usage report, the information processing apparatus 100 describes, as a smart contract, that redistribution processing is to be performed on the music publishing company 35 on a date set in advance, whereby the above processing is automatically executed.

In addition, the information management system 50 reports the copyright usage fee and the master disk usage fee paid for the music, the distribution information, and the like to the information processing apparatus 100 (Step S25). In addition, the information management system 50 pays the master royalties related to the distributed master disk usage fee to the creator 20 (Step S26). Further, the information management system 50 pays the copyright royalties related to the distributed copyright usage fee to the creator 20 (Step S27). The processing executed by the information management system 50 may be automatically executed on the basis of the smart contract similarly to Step S24. Note that the master royalties and the copyright royalties may be assigned to the creator 20 or other copyright holders (such as a copyright holder of a material used in the music) in a form of a token that can be transmitted on the blockchain.

As described above, according to the information processing system 1, it is possible to assign copyright information such as a copyright to music using the function of the DAW provided by the information processing apparatus 100. Furthermore, the information processing system 1 can smoothly execute registration of rights, distribution of a usage fee, and the like by centrally managing rights related to music using a blockchain such as the information management system 50.

The outline of the processing according to the information processing system 1 has been described above with reference to FIGS. 1 and 2. Next, information processing related to the DAW provided by the information processing apparatus 100 will be described in detail with reference to FIG. 3 and subsequent drawings.

### 1-2. Example of Sound Source Separation Processing According to Embodiment

As described above, the DAW provided by the information processing apparatus 100 has various functions that can be used when the creator 20 produces music.

Hereinafter, sound source separation as an example of the functions will be described.

FIG. 3 is a diagram illustrating an outline of sound source separation processing according to the embodiment. FIG. 3 is a schematic block diagram illustrating a flow of processing when the information processing apparatus 100 performs sound source separation.

When the creator 20 requests to execute the sound source separation on the DAW, the creator terminal 10 accesses a creator sound source storage unit 60 included in the information processing apparatus 100 (Step S31). The creator sound source storage unit 60 stores music data being produced by the creator 20, sound sources produced by the creator 20 in the past, sound sources and materials purchased in the past, and the like.

The creator 20 selects a sound source for which sound source separation is desired to be executed among sound sources stored in the creator sound source storage unit 60. The information processing apparatus 100 sends the selected sound source to a sound source separation system 70 (Step S32).

The sound source separation system 70 has a function of separating a predetermined sound from an original sound source to be separated according to a request of the creator 20. For example, the sound source separation system 70 is a plug-in that functions on a DAW. In the sound source separation system 70, the information processing apparatus 100 executes sound source separation in accordance with a request from the creator 20. For example, in a case where the creator 20 requests to separate the sound of the guitar from the sound source, the information processing apparatus 100 generates the guitar sound source separated from the sound source. Then, the information processing apparatus 100 sends the generated guitar sound source to the creator sound source storage unit 60 (Step S33).

Here, in order to search whether a sound source similar to the generated guitar sound source exists in a music distribution store, a material sales store, or the like (hereinafter, simply collectively referred to as “store”) in cooperation with the DAW, the information processing apparatus 100 sends the guitar sound source to a similar sound source search system 75 (Step S34).

The similar sound source search system 75 has a function of searching for a sound source similar to a target by determining whether or not a sound source of a certain target is similar to any sound source. For example, the similar sound source search system 75 is a plug-in that functions on a DAW. In the search, the similar sound source search system 75 acquires the sound source from a store sound source storage unit 65 that stores the sound sources held by the store (Step S35). In the example of FIG. 3, the information processing apparatus 100 uses the function of the similar sound source search system 75 to search the store sound source storage unit 65 for a sound source similar to the guitar sound source generated by the sound source separation system 70. Then, in a case where a similar sound source is searched, the information processing apparatus 100 sends the search result to the creator terminal 10 (Step S36). The creator 20 can arbitrarily select the sound source for which the creator has performed sound source separation or a sound source searched by the information processing apparatus 100 and use the sound source for music production.

Note that, in Step S32, the creator 20 may search the store in addition to the sound sources stored in the creator sound source storage unit 60, and acquire the sound source for which sound source separation is desired to be executed. For example, the creator 20 can search for existing music and materials by designating a material genre, a tempo, a BPM, a key, and the like in the search system on the DAW. In this case, in the DAW, the information processing apparatus 100 may provide a function for the creator 20 to listen to the searched sound source, a function for changing the tempo and key of the sound source, and the like. Furthermore, when the creator 20 acquires a sound source for which sound source separation is desired to be executed, the information processing apparatus 100 may make an inquiry to the information management system 50 to refer to whether or not the music to be downloaded is truly registered or the like.

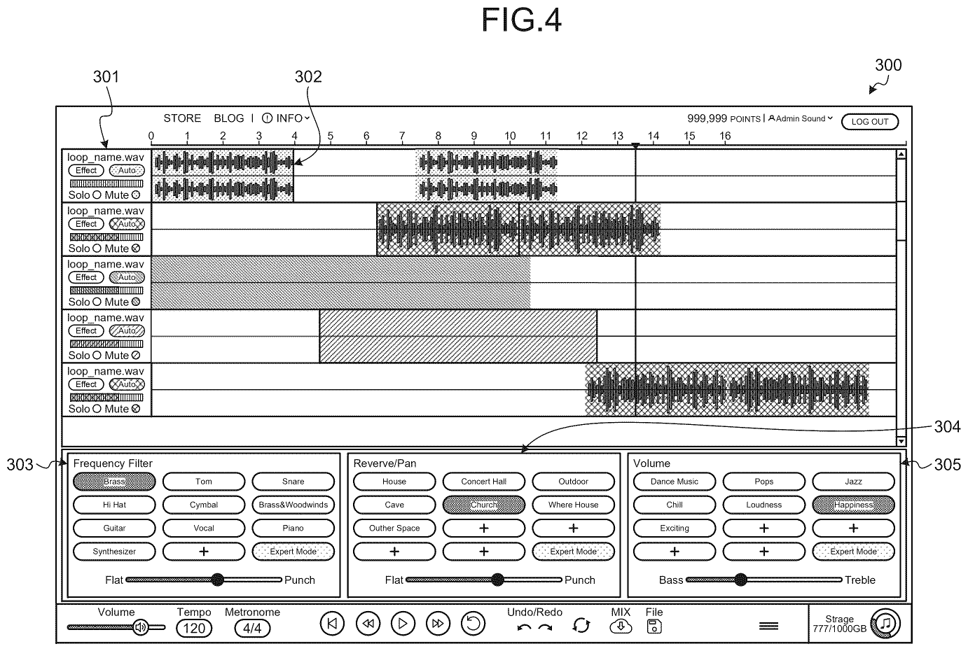

The flow of the processing related to the sound source separation has been described above with reference to FIG. 3. Next, an example of a user interface when sound source separation is executed on the DAW will be described with reference to FIG. 4 and subsequent drawings.

FIG. 4 is a diagram (1) illustrating the user interface according to the embodiment. FIG. 4 illustrates a screen 300 on the DAW and various types of information included in the screen 300.

As illustrated in FIG. 4, the screen 300 includes a track display 301 indicating each track in music production and a waveform 302 indicating a sound source included in the track. Furthermore, the screen 300 includes filter information 303 used for editing the sound source, pan information 304 indicating localization for each track, equalizer information 305 for adjusting the frequency of the sound source or the music, and the like. Note that the screen 300 illustrates a general screen example of a DAW that produces music for the purpose of describing the embodiment, and the functions and information included in the DAW according to the embodiment are not limited thereto.

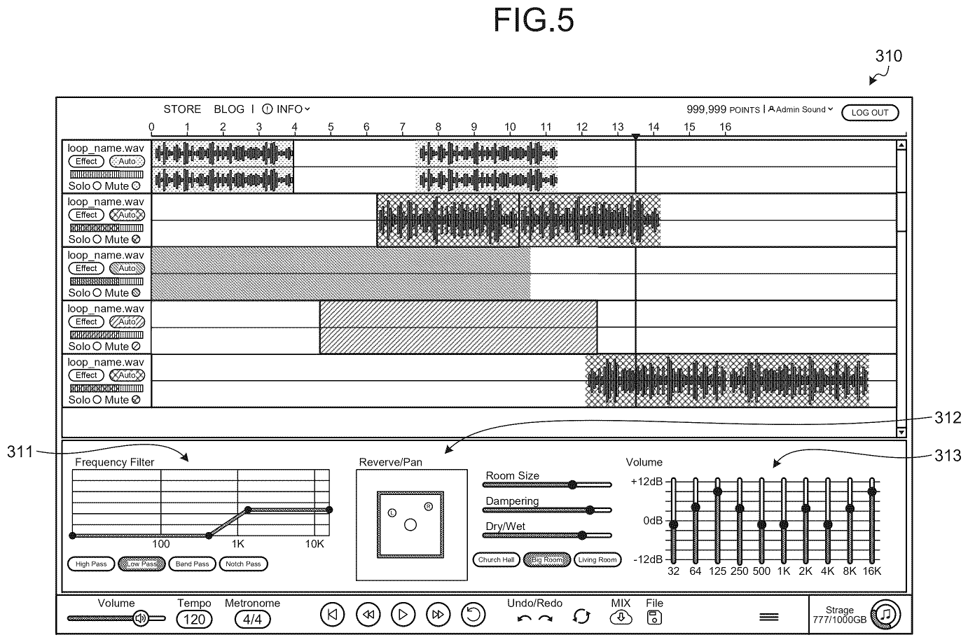

Next, another display example of the functions included in the DAW will be described with reference to FIG. 5. FIG. 5 is a diagram (2) illustrating the user interface according to the embodiment. FIG. 5 illustrates a screen 310 on the DAW and various types of information included in the screen 310.

As illustrated in FIG. 5, the screen 310 includes filter information 311 indicating the filter information 303 in another display example, pan information 312 indicating the pan information 304 in another display example, and equalizer information 313 indicating the equalizer information 305 in another display example.

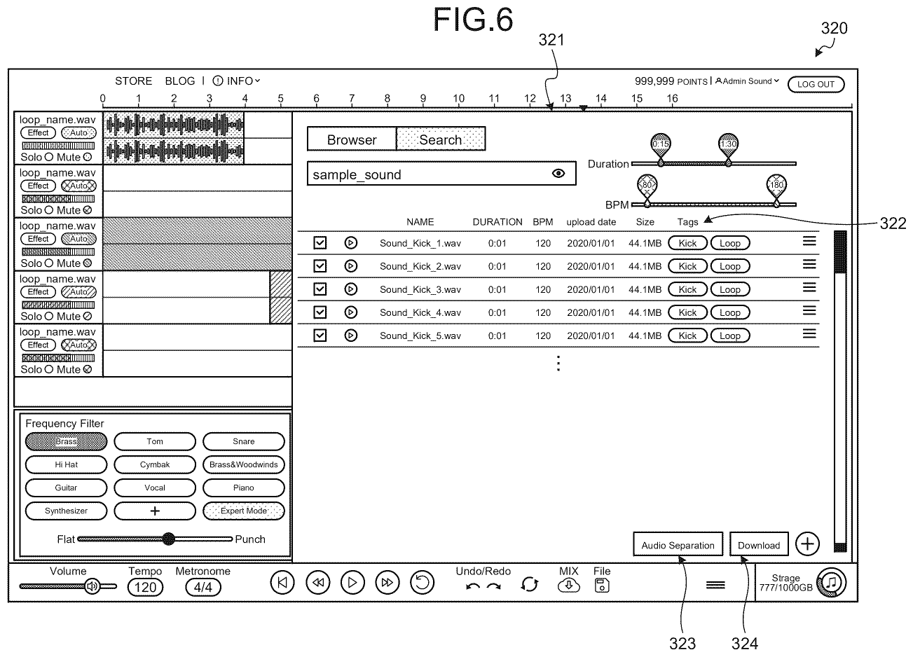

Next, a display example when the DAW executes the sound source separation will be described with reference to FIG. 6. FIG. 6 is a diagram (3) illustrating the user interface according to the embodiment. FIG. 6 illustrates a screen 320 on the DAW and various types of information included in the screen 320.

In a case of executing the sound source separation, the creator 20 displays a window 321 for displaying a list of sound sources included in the track being produced on the DAW. In the window 321, a list of sound sources included in each track is displayed. For example, the list includes the name of the sound source, the reproduction time of the sound source, the tempo (indicated by beats per minute (BPM) or the like), the date and time of addition to the track, the sound source information such as the sampling frequency, the tag information 322 automatically assigned by the analysis of the sound source, and the like. Note that the window 321 may include not only the sound sources included in the track but also the store sound sources searched by the creator 20.

The creator 20 selects a desired sound source and clicks a button 323 on the DAW to command sound source separation. In addition, in a case where it is desired to confirm the sound source or in a case where it is desired to acquire the store sound source, the creator 20 clicks a button 324 and downloads the sound source to the creator terminal 10 which is a local terminal.

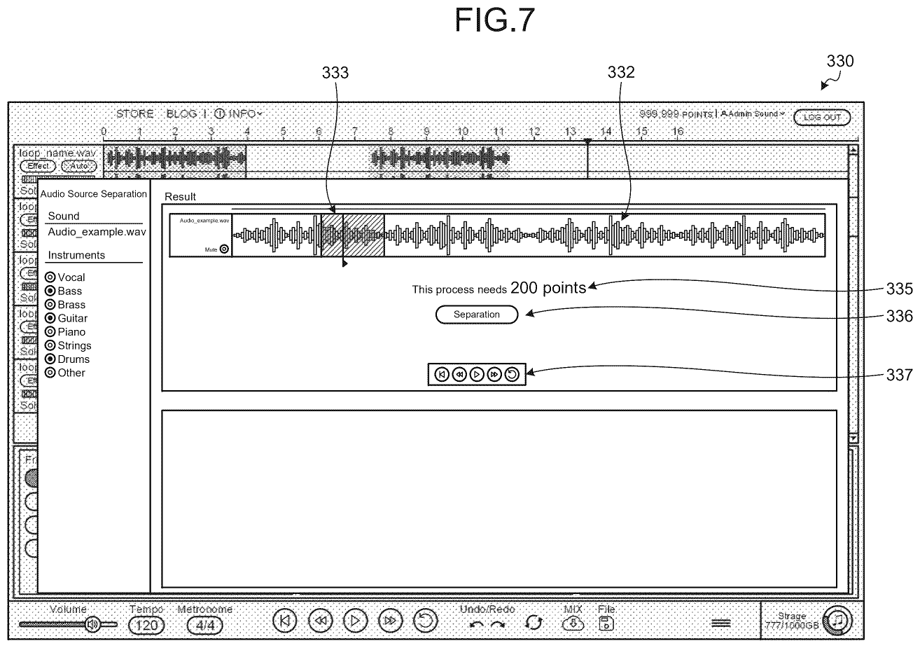

In a case where the button 323 is clicked in FIG. 6, the screen 320 transitions to a screen 330 illustrated in FIG. 7. FIG. 7 is a diagram (4) illustrating the user interface according to the embodiment. FIG. 7 illustrates the screen 330 on the DAW and various types of information included in the screen 330.

In the example illustrated in FIG. 7, it is assumed that the creator 20 selects the sound source 332 as the sound source for sound source separation. Further, the creator 20 may select a part of the sound sources 332 where sound source separation is actually performed. In the example illustrated in FIG. 7, it is assumed that the creator 20 selects the waveform 333 as a part where sound source separation is performed.

Subsequently, the creator 20 selects a musical instrument from the item 334 to select a musical instrument for which sound source separation is desired. For example, in a case where it is desired to separate the sounds of the bass, the guitar, and the drum from the sound sources included in the waveform 333, the creator 20 selects the corresponding buttons.

Here, the information processing apparatus 100 presents information necessary for sound source separation to the creator 20. The information necessary for the sound source separation is, for example, a copyright usage fee paid by the creator 20 to the copyright holder of the sound source, a usage fee set in advance in the material, or the like. In the example of FIG. 7, it is assumed that the information necessary for performing the sound source separation is indicated by a predetermined point in cooperation with the store. For example, the information processing apparatus 100 calculates points necessary for processing on the basis of the time of the waveform 333 and the number of musical instruments for which sound source separation is performed. Then, the information processing apparatus 100 displays a charging information 335 indicating the calculated points on the screen 330.

After confirming the waveform 333 for sound source separation, the item 334, and the charging information 335, the creator 20 clicks a button 336 in a case where it is desired to execute sound source separation. As a result, the information processing apparatus 100 executes sound source separation. Note that, in a case where it is desired to confirm the contents of the sound source 332 and the waveform 333 before executing the sound source separation, the creator 20 can operate a operation panel 337 to reproduce the sound source 332 and the waveform 333, and the like.

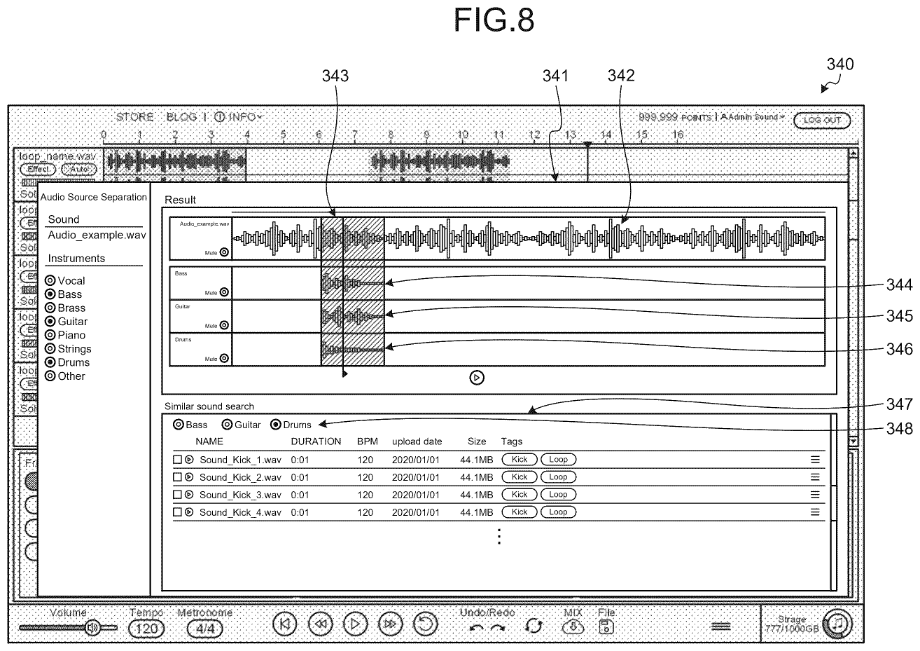

In a case where the button 336 is clicked in FIG. 7, the screen 330 transitions to a screen 340 illustrated in FIG. 8. FIG. 8 is a diagram (5) illustrating the user interface according to the embodiment. FIG. 8 illustrates a screen 340 on the DAW and various types of information included in the screen 340.

The screen 340 has a window 341. In the window 341, a sound source 342 for which sound source separation is executed and a waveform 343 that is a part where sound source separation is actually performed are displayed.

In a case where the creator 20 requests sound source separation of the waveform 343, the information processing apparatus 100 executes sound source separation. Specifically, the information processing apparatus 100 inputs the waveform 343 to a sound source separation model in which a feature of each sound source constituting the music is learned in advance, and generates the sound source separated from the waveform 343 in a format that can be used on the DAW. The feature of each sound source constituting the music is, for example, a tone that characterizes each musical instrument such as a vocal, a guitar, and a bass. That is, the information processing apparatus 100 executes the sound source separation using a model obtained by machine learning the features of the individual musical instruments and outputting a new sound source having only the features of the individual musical instruments from a certain sound source in a case where the certain sound source is input.

In a case where the sound source separation is performed on the waveform 343, each of a waveform 344, a waveform 345, and a waveform 346 is displayed side by side in the waveform 343 on the DAW. For example, waveform 344 is a sound source obtained by extracting the bass sound from the sound source indicated by the waveform 343. Furthermore, the waveform 345 is a sound source obtained by extracting the guitar sound from the sound source indicated by the waveform 343. Furthermore, the waveform 346 is a sound source obtained by extracting the drum sound from the sound source indicated by the waveform 343. In this manner, the information processing apparatus 100 generates sound sources separated for each musical instrument in a format that can be immediately used on the DAW from the sound source desired by the creator 20. As a result, the creator 20 can quickly and accurately acquire a sound material desired to be used for own music production.

Furthermore, after executing the sound source separation, the information processing apparatus 100 searches the store sound source storage unit 65 for a sound source similar to the sound source after the separation. For example, the information processing apparatus 100 determines similarity between the separated sound source and the sound sources (materials) stored in the store sound source storage unit 65 using a known similarity analysis function for determining similarity for each music or sound source, and extracts a sound source having a relatively high similarity.

The information processing apparatus 100 displays the search result in a window 347. The window 347 illustrates an example of a result in a case where the creator 20 clicks a selection button 348 and requests to designate the drum of the musical instrument to search for the material. That is, the sound source displayed in the search result illustrated in the window 347 is a sound source similar to the waveform 346 which is the separated drum sound source and is a sound source stored in the store sound source storage unit 65. The creator 20 may use the sound source of the waveform 346 in music production, or may listen to the searched similar sound source and acquire or purchase a favorite sound source to use.

The flow of the processing related to the sound source separation has been described above with reference to FIGS. 3 to 8. Note that the separated sound source is not necessarily the sound source of which the creator 20 is the copyright holder. In addition, the creator 20 may produce music using a similar sound source purchased from the store instead of the sound source subjected to sound source separation. Therefore, in the DAW, the information processing apparatus 100 provides a copyright management function together with the sound source separation function.

### 1-3. Example of Right Information Assignment According to Embodiment

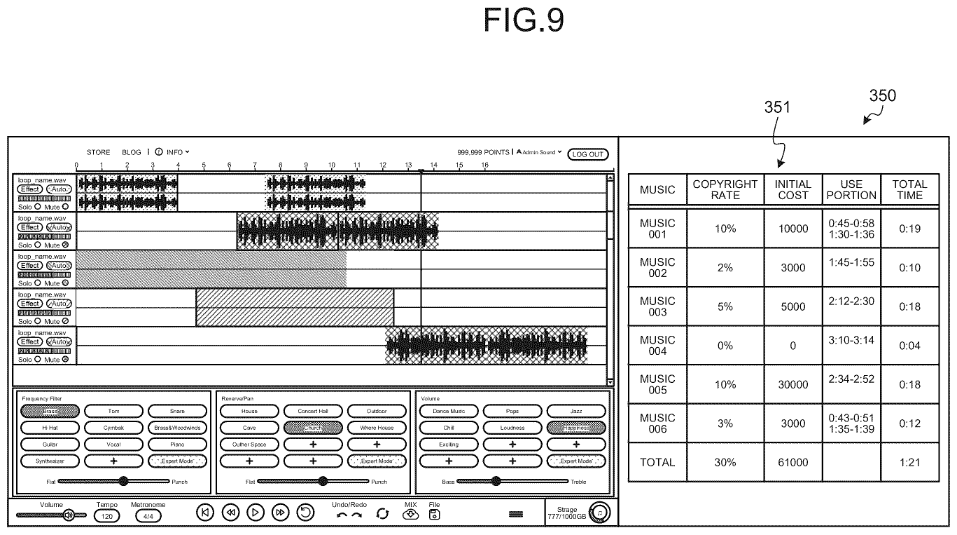

As described above, the DAW provided by the information processing apparatus 100 has a function of managing copyright information when the creator 20 produces music. In FIG. 9 and the following, right information assignment, which is an example of the function of the DAW, will be described.

FIG. 9 is a diagram (6) illustrating the user interface according to the embodiment. In the example of FIG. 9, a screen 350 on which the creator 20 is producing music on the DAW and various pieces of information included in the screen 350 are illustrated.

As illustrated in FIG. 9, each track of the music to be produced by the creator 20 and the sound source included in the track are displayed in a waveform form on the left half of the screen 350. These waveforms include a part of existing music, a material purchased from a store, and the like together with a sound source generated by recording or typing by the creator 20 itself.

When the creator 20 adds a sound source to a track to be used for music production, the information processing apparatus 100 acquires right information of the sound source. For example, the information processing apparatus 100 acquires, as the right information, copyright information assigned to the sound source. Furthermore, the information processing apparatus 100 acquires information regarding use permission of the sound source as the right information. Specifically, the information processing apparatus 100 acquires information such as whether or not the sound source is permitted to be used for another piece of music production, a use time and a use part permitted in a case where the sound source is used for another piece of music production, and a fee paid to the original copyright holder in a case where the sound source is used.

The information processing apparatus 100 displays the acquired right information in a window 351. As illustrated in FIG. 9, the window 351 includes information such as the name of the music used as the sound source, the copyright rate of the music (for example, the rate set by the right holder for each use form), the initial cost (the amount paid to the original copyright holder when the existing music is used), the use portion (the part where the existing music is used in the music), and the total time (the total time in which the existing music is used in the music).

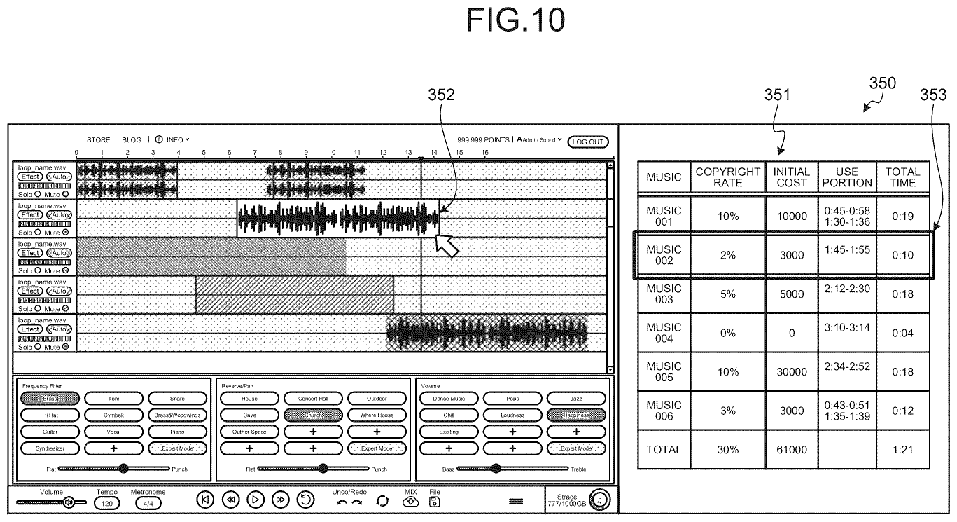

The creator 20 can select which sound source is actually used for the music with reference to the information displayed in the window 351. In addition, the creator 20 can refer to what kind of right information is set to which sound source at a glance. This point will be described with reference to FIG. 10. FIG. 10 is a diagram (7) illustrating the user interface according to the embodiment.

In the example illustrated in FIG. 10, a state in which the creator 20 selects a waveform 352 on the screen 350 is illustrated. At this time, the information processing apparatus 100 may highlight the waveform 352 such that the waveform 352 stands out from other waveforms. In addition, the information processing apparatus 100 may highlight a right information 353 corresponding to the waveform 352 in the window 351 so as to stand out. As a result, the creator 20 can confirm the cost in a case where the waveform 352 is used in the music, the total time of the waveform 352 to be used in the music, and the like. Note that, for example, in a case where the creator 20 performs an operation to use the waveform 352 for more time in the subsequent processing, the information processing apparatus 100 may calculate the usage fee in real time and update the information displayed in the right information 353.

As described above, in a case of producing music including the sound source and the like downloaded by the creator 20, the information processing apparatus 100 executes the management function for the right information of the sound source in the background without impairing the operability as a normal DAW. For example, such a management function manages music production while updating a range and a part used for music, a total use time, and the like, in addition to original sound source information itself used for sampling music. For this reason, even in a case where another person's sound source is used for sampling, the creator 20 does not need to memorize how long, in what mode the sound source is used, and the like, and can manage the sampling sound source without being particularly conscious.

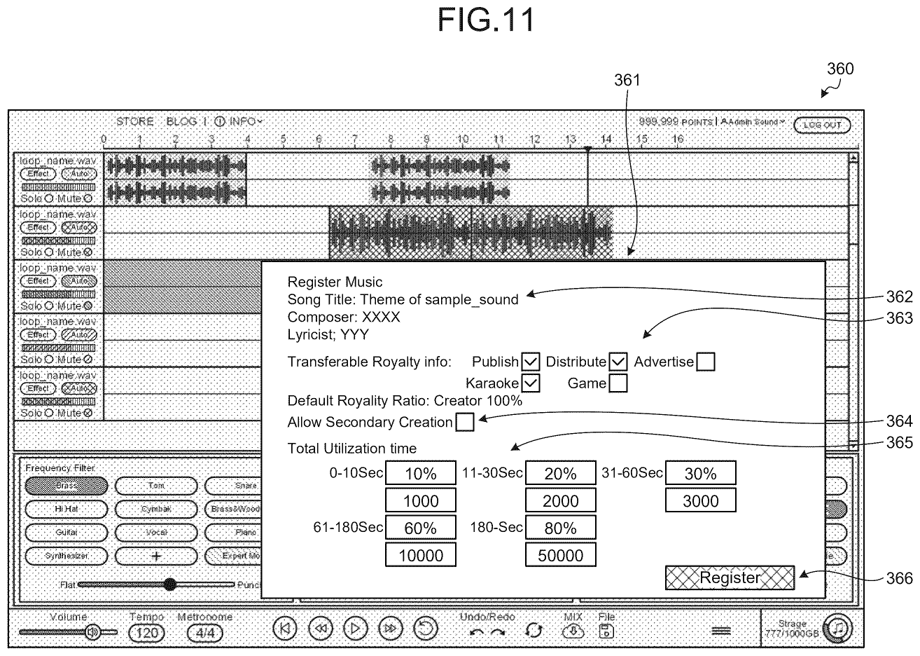

Next, a process of registering the right information in the music in a case where the creator 20 completes the music production will be described. FIG. 11 is a diagram (8) illustrating the user interface according to the embodiment. In the example of FIG. 11, a screen 360 on which the creator 20 is registering the right information in the music on the DAW and various pieces of information included in the screen 360 are illustrated.

As illustrated in FIG. 11, when the creator 20 tries to register the right information in the music, the information processing apparatus 100 displays a window 361. The window 361 is a display unit for setting right information to be registered by the creator 20.

For example, the creator 20 inputs the name of the music to an item 362. In addition, the creator 20 can select whether or not the music can be transferred or entrusted to a predetermined field of use by checking the check box indicated in an item 363. For example, in the example of FIG. 11, the creator 20 can select each of whether the music can be transferred to a publisher, can be transferred to a distribution site or the like, can be transferred to an advertising company, can be transferred to a karaoke company, or can be transferred to a game company.

In addition, the creator 20 can select whether or not to permit the secondary use of the music after the music is released (for example, registered in the store) by checking the check box indicated in an item 364. The secondary use of the music means, for example, that a third party produces new music using a part of the music.

The creator 20 can also set more detailed information regarding secondary use. For example, the creator 20 can arbitrarily set the use time and the copyright rate displayed in an item 365. In the example of FIG. 11, the creator 20 sets that the copyright rate is 10% and the initial cost is 1000 yen in a case where the use time in the secondary use is within 10 seconds.

When the setting of the right information is completed, the creator 20 clicks a button 366. Thus, the creator 20 can register the music together with the right information. For example, the information processing apparatus 100 registers the music in a store linked with the DAW.

When music is newly registered, the information processing apparatus 100 may message a request for a usage contract to the copyright holder or the like of the original sound source. After confirming the mode of use, the copyright holder transmits permission of the usage contract to the information processing apparatus 100. Note that such processing may be performed using a smart contract on a blockchain. In this case, the copyright holder or the like writes in advance in the smart contract that “the use is permitted as long as in accordance with the use condition”, so that the creator 20 can complete the use permission of the sound source and the new registration of the music by an automatic contract with almost no waiting time.

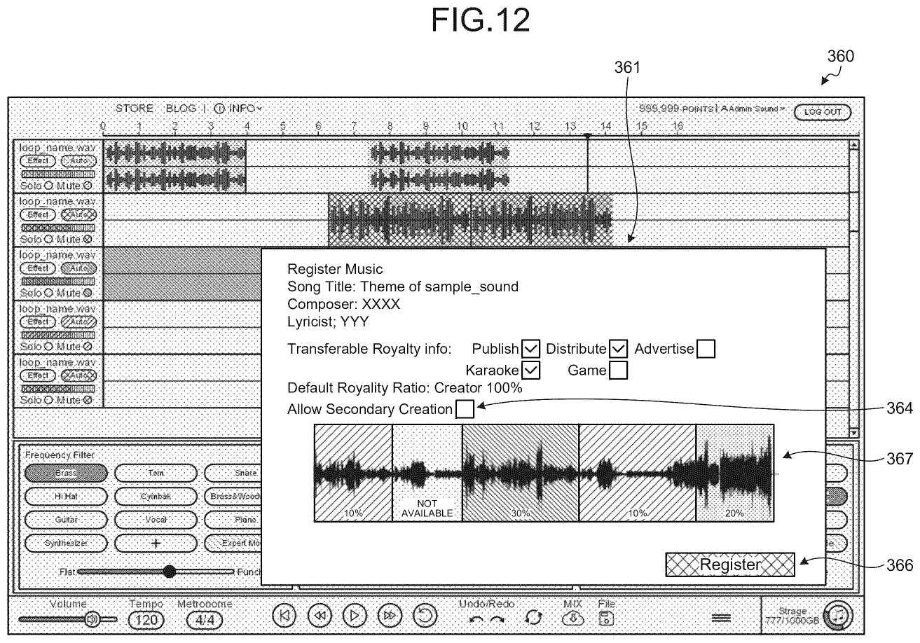

Next, a modification of the setting of the right information will be described with reference to FIG. 12. FIG. 12 is a diagram (9) illustrating the user interface according to the embodiment. FIG. 12 illustrates an example in which a music waveform 367 is displayed in the window 361 illustrated in FIG. 11.

The music waveform 367 indicates the entire music produced by the creator 20 in a waveform. For example, when allowing secondary use of the music, the creator 20 can set a permission setting and a fee according to a part of the music, such as permitting intro but not permitting A melody and permitting chorus. Specifically, the creator 20 refers to the music waveform 367 and sets a part that he/she allows for secondary use, a fee thereof, and the like. In the example of FIG. 11, the creator 20 sets the copyright rate to 10% in a case where the intro is secondarily used, and sets not to permit the secondary use for the A melody. In addition, the creator 20 can arbitrarily set the permitted part and fee, such as setting the copyright rate of the intro to be low at 10%, but setting the copyright rate of the chorus to be high at 30%. After completing the setting of the right information, the creator 20 clicks the button 366 similarly to the example of FIG. 11.

In a case where the button 366 is clicked in the example of FIGS. 11 and 12, the information processing apparatus 100 registers the music, refers to the right information included in the music, and executes various processes on the basis of the referred information. For example, the information processing apparatus 100 transmits information indicating a mode in which the existing music is used to the original copyright holder of the existing music used by the music. Furthermore, the information processing apparatus 100 assigns the right information regarding the music on the basis of the information set by the creator 20 or the copyright information of the existing music. The information processing apparatus 100 writes the assigned right information in a blockchain such as the information management system 50 illustrated in FIG. 1 so that all related persons can refer to the right information and tampering can be prevented.

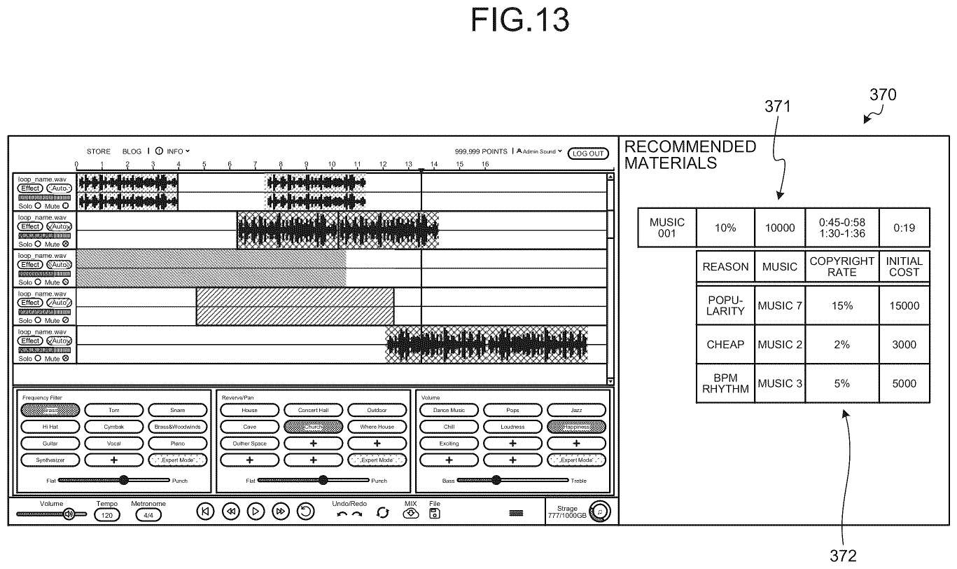

Next, a recommendation function in music production will be described with reference to FIG. 13. FIG. 13 is a diagram (10) illustrating the user interface according to the embodiment. In the example of FIG. 13, a screen 370 on which the creator 20 is producing music on the DAW and various pieces of information included in the screen 370 are illustrated.

As illustrated in FIG. 9 and the like, the creator 20 can confirm information of a sound source to be used by the creator during music production on the DAW.

Here, the information processing apparatus 100 may crawl the store sound source storage unit 65 or the website on the basis of the sound source to be used by the creator 20, and display the sound sources to be recommended in a window 371.

For example, the information processing apparatus 100 searches for a sound source similar to the music 001 that the creator 20 intends to use. Then, the information processing apparatus 100 extracts a sound source to be recommended to the creator 20 from the searched sound source according to a predetermined determination criterion. For example, the information processing apparatus 100 presents a similar sound source with a lower usage fee to the creator 20. Alternatively, the information processing apparatus 100 presents, to the creator 20, a popular sound source that is widely used by other users among similar sound sources. Alternatively, the information processing apparatus 100 presents, to the creator 20, a sound source having the beat feeling most similar to that of the music 001 (for example, the BPM or the rhythm of the drum is matched or the like) among similar sound sources. As illustrated in a list 372, the information processing apparatus 100 displays a reason for recommendation, a name of music (sound source), a copyright rate in a case where the music is used, an initial cost, and the like, as the information regarding the recommended sound source. As a result, the creator 20 can actively use an unknown sound source, thus providing more scope for music production. In addition, the creator 20 can produce music while suppressing the cost of the copyright usage fee by selecting a sound source for which the usage fee is set to be low.

The flow of the processing related to the right information assignment has been described above with reference to FIGS. 9 to 13. By implementing functions such as sound source separation and right information assignment on the DAW, the information processing apparatus 100 can simplify complicated procedures conventionally performed by the creator 20, such as collection of sound materials and right processing.

### 1-4. Configuration of Information Processing Apparatus According to Embodiment

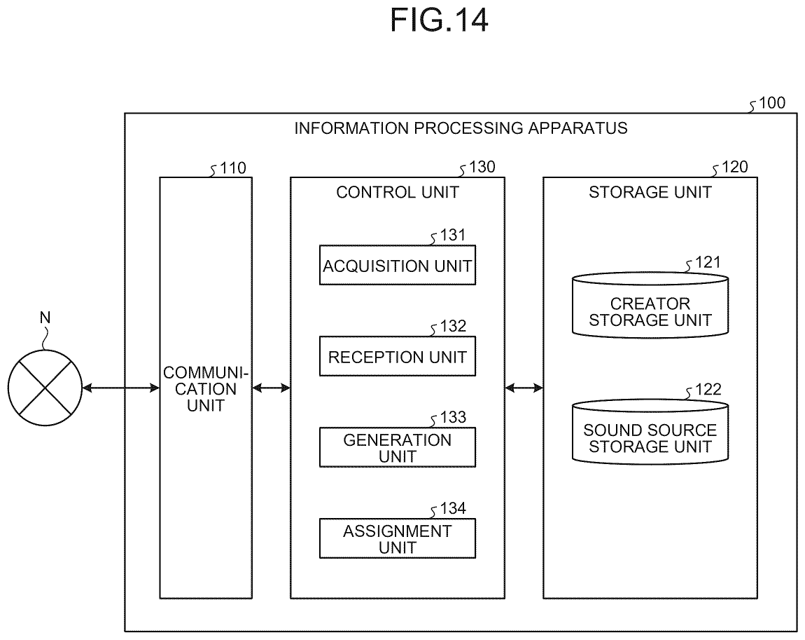

Next, a configuration of the information processing apparatus 100 according to the embodiment will be described. FIG. 14 is a diagram illustrating a configuration example of the information processing apparatus 100 according to the embodiment of the present disclosure.

As illustrated in FIG. 14, the information processing apparatus 100 includes a communication unit 110, a storage unit 120, and a control unit 130. Note that the information processing apparatus 100 may include an input unit (for example, a keyboard, a mouse, or the like) that receives various operations from a manager or the like who manages the information processing apparatus 100, and a display unit (for example, a liquid crystal display or the like) for displaying various types of information.

The communication unit 110 is implemented by, for example, a network interface controller, a network interface card (NIC), or the like. The communication unit 110 is connected to a network N (the Internet or the like) in a wired or wireless manner, and transmits and receives information to and from an external apparatus such as the creator terminal 10 or in a blockchain such as the information management system 50 via the network N.

The storage unit 120 is implemented by, for example, a semiconductor memory element such as a random access memory (RAM) or a flash memory, or a storage apparatus such as a hard disk or an optical disk. The storage unit 120 includes a creator storage unit 121 and a sound source storage unit 122. Hereinafter, each storage unit will be described in order.

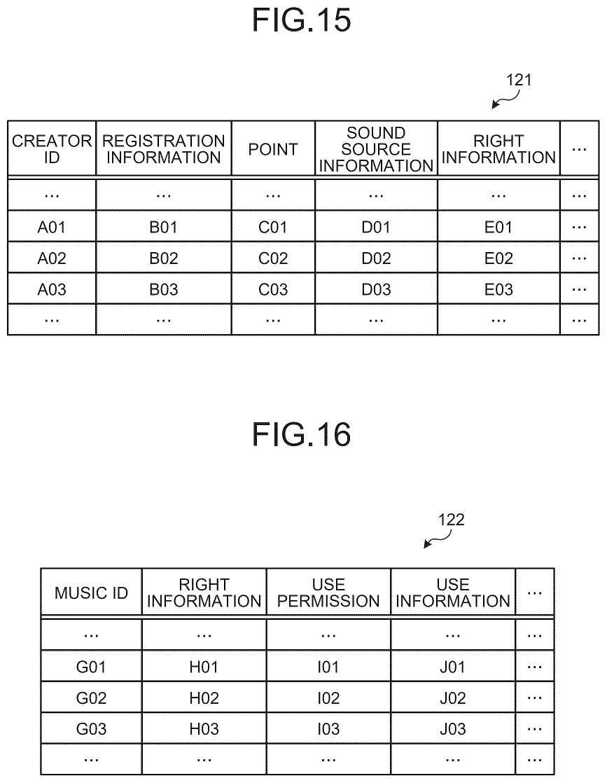

FIG. 15 is a diagram illustrating an example of the creator storage unit 121 according to the embodiment. As illustrated in FIG. 15, the creator storage unit 121 includes items such as “creator ID”, “registration information”, “point”, “sound source information”, and “right information”. Note that, in FIGS. 15 and 16, the information stored in the storage unit 120 is conceptually illustrated as “A01”, but in practice, each piece of information described later is stored in the storage unit 120. The creator storage unit 121 corresponds to, for example, the creator sound source storage unit 60 illustrated in FIG. 3.

The “creator ID” is identification information for identifying the creator. The “registration information” is an account name of the creator, information used when using the DAW, and the like.

The “point” is information regarding a point required when the creator uses a service (for example, sound source separation on DAW, and the like) provided by the information processing apparatus 100. Note that, in the embodiment, an example is illustrated in which the creator consumes points as a compensation for service, but the compensation may be currency, a token issued on a blockchain, or the like.

The “sound source information” is information regarding a sound source owned by the creator. For example, the sound source information includes a sound source recorded by the creator on the DAW, existing music and sound materials purchased by the creator on a site or the like, and music produced by the creator on the DAW.

The “right information” is information regarding the right registered by the creator. For example, the right information is registered for each piece of music, and includes various types of information such as a name of the music, a copyright holder in the music, a use permission when using the music, and a use condition (a use fee according to a use time and a use part).

Next, the sound source storage unit 122 will be described. FIG. 16 is a diagram illustrating an example of the sound source storage unit 122 according to the embodiment. As illustrated in FIG. 16, the sound source storage unit 122 includes items such as “music ID”, “right information”, “use permission”, and “use information”. The sound source storage unit 122 corresponds to, for example, the store sound source storage unit 65 illustrated in FIG. 3.

The “music ID” is identification information for identifying music held in the sound source storage unit 122. The music stored in the sound source storage unit 122 is, for example, music distributed or sold from a store in cooperation with the DAW.

The “right information” is information regarding a right registered in music. For example, the right information is information registered for each piece of music and held as metadata different from music data (for example, music data such as a wav file). For example, the right information includes information for identifying the copyright holder in the music, the distribution intermediary of the music, the music publishing company that manages the right of the music, and the like.

The “use permission” is information regarding permission when the music is secondarily used. For example, the use permission is registered for each piece of music, and includes various types of information such as a use permission when the music is used and a use condition (a use fee according to a use time or a use part).

The “use information” is history information in which music is used. For example, the use information is the number of times the music is listened to from the user, the time, the number of times the music is downloaded, the number of times the music is secondarily used and a part of the music is used for new music, the time included in the new music, the number of times and the time the new music is listened to, the number of times the new music is downloaded, and the like. In addition, the use information may include information such as a copyright usage fee paid when the music is secondarily used.

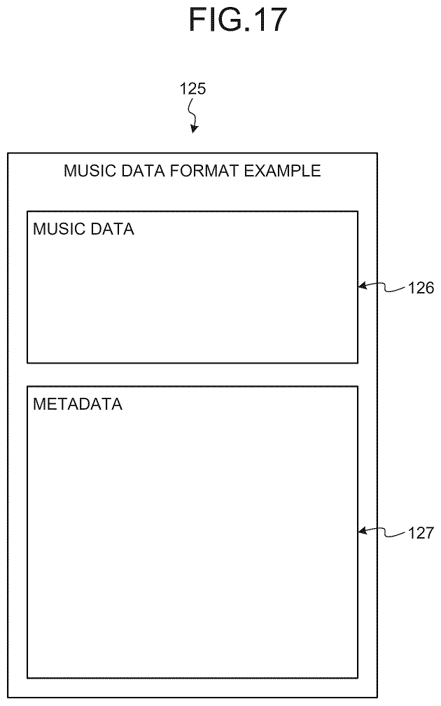

Here, information included in the music data according to the embodiment will be described with reference to FIG. 17. FIG. 17 is a diagram illustrating a concept of music data according to the embodiment.

As illustrated in FIG. 17, music data 125 which is an example of the music data format according to the embodiment includes music data 126 and metadata 127. The music data 126 is digital data (binary data) obtained by sampling music, such as a wav file. The metadata 127 includes various kinds of information related to music. For example, the metadata 127 includes the right information, the permission information, the use information, and the like illustrated in FIGS. 15 and 16. That is, the metadata 127 includes information such as a name of music, author information, and new music produced by secondary use. Information for identifying each new piece of music produced by secondary use or the like is registered as metadata. As a result, in a case where the information processing apparatus 100 refers to certain music data, it is possible to specify a newly produced music by secondarily using the music and to specify information such as how long and where the music is used in the newly produced music. The music data 125 illustrated in FIG. 17 is stored in the creator storage unit 121, the sound source storage unit 122, and the like.

Note that the information processing apparatus 100 stores information regarding each creator and information regarding a sound source in the information illustrated in FIGS. 15 and 16. Furthermore, the information processing apparatus 100 registers the information illustrated in FIGS. 15 and 16 in the information management system 50 (blockchain). That is, the information illustrated in FIGS. 15 and 16 can be referred to and updated by not only the information processing apparatus 100 but also the distribution intermediary 30, the music publishing company 35, the copyright manager 40, and the like by the distributed ledger system based on the blockchain.

Returning to FIG. 14, the description will be continued. The control unit 130 is implemented by, for example, a central processing unit (CPU), a micro processing unit (MPU), a graphics processing unit (GPU), or the like executing a program (for example, an information processing program according to the present disclosure) stored inside the information processing apparatus 100 with a random access memory (RAM) or the like as a work area. Furthermore, the control unit 130 is a controller, and may be implemented by, for example, an integrated circuit such as an application specific integrated circuit (ASIC) or a field programmable gate array (FPGA).

As illustrated in FIG. 14, the control unit 130 includes an acquisition unit 131, a reception unit 132, a generation unit 133, and an assignment unit 134, and implements or executes a function and an action of information processing described below. Note that the internal configuration of the control unit 130 is not limited to the configuration illustrated in FIG. 14, and may be another configuration as long as information processing to be described later is performed.

The acquisition unit 131 acquires various types of information. For example, the acquisition unit 131 acquires the sound source uploaded by the creator 20 via the DAW which is a cloud application provided to the creator terminal 10. Note that, in the following description, a sound source or existing music that can be a material of music production may be referred to as “first content” for distinction. Further, new music produced by the creator 20 may be referred to as “second content”. That is, the acquisition unit 131 acquires the first content from the creator terminal 10. Note that the acquisition unit 131 may acquire the first content via a store or the like.

In addition, the acquisition unit 131 acquires the right information assigned to the first content in advance. The right information assigned in advance to the first content is various kinds of information registered when the first content is generated, and for example, the right information illustrated in FIG. 15 corresponds to the right information.

Specifically, the acquisition unit 131 acquires, as the right information, information regarding permission and use conditions regarding secondary use set in the first content. In addition, the acquisition unit 131 may acquire, as the right information, information regarding a plurality of right holders who permit the secondary use of the first content. For example, the acquisition unit 131 acquires information on a right holder having a copyright regarding the first content. In addition, in a case where the first content is secondarily used, the acquisition unit 131 acquires names of a plurality of copyright holders whose permission is to be obtained, access destinations of the copyright holders, access destinations of the associations that manage the copyright, and the like.

In addition, the acquisition unit 131 may acquire, as the right information, information regarding a permission and a use condition regarding distribution of the content produced by secondarily using the first content. Specifically, in a case where new music is produced by secondarily using the first content, the acquisition unit 131 acquires whether or not distribution of the new music is permitted, and a copyright usage fee, a copyright rate, and the like in a case of distribution. In addition, the acquisition unit 131 acquires a use condition such as whether or not distribution is permitted according to a use time or a use rate (a ratio of the first content to the second content) of the first content. For example, the acquisition unit 131 acquires the use condition registered in the first content, such as permitting distribution if the use time of the first content is within 1 minute or the use rate of the first content is 20% or less of the reproduction time of the second content.

Furthermore, the acquisition unit 131 may acquire a sound source or the like other than the first content uploaded by the creator 20 during music production or the like in the DAW. For example, the acquisition unit 131 acquires a similar sound source that is a sound source similar to the first content from the sound source storage unit 122 or each site on the network N.

The reception unit 132 receives a request for separating the first content acquired by the acquisition unit 131 into a plurality of sound sources from a user (the creator 20 in the embodiment) who uses the DAW.

The reception unit 132 may calculate a compensation borne by the creator 20 in order to execute processing of separating the first content into a plurality of sound sources, present the calculated compensation to the creator 20, and then receive a request for separating the first content into a plurality of sound sources from the creator 20. For example, the reception unit 132 presents a point required for separation as illustrated in FIG. 7 to the creator 20.

For example, the reception unit 132 may calculate the compensation on the basis of the reproduction time of the first content for which the sound source separation is executed, the number of sound sources to be newly generated by the separation, the popularity (use history from other creators, the number of views of the first content, and the like) of the first content, and the like.

Note that the reception unit 132 may receive a request for separating not all but a part of the first content from the creator 20. As a result, the generation unit 133 described later can execute processing more quickly than sound source separation of the entire first content.

On the basis of the request received by the reception unit 132, the generation unit 133 generates the sound source separated from the first content in a format that can be used on the DAW by inputting the first content to the model in which the feature of each sound source constituting the music is learned in advance. The generation unit 133 corresponds to the sound source separation system 70 and the similar sound source search system 75 illustrated in FIG. 3.

For example, the generation unit 133 generates a sound source of each musical instrument separated from the first content in a format that can be used on the DAW by inputting the first content to a model in which the feature of each musical instrument constituting the music is learned in advance.

Furthermore, after generating the sound source separated from the first content, the generation unit 133 may present a similar sound source, which is a sound source similar to the sound source, to the creator 20.

For example, the generation unit 133 presents, as similar sound sources, a musical instrument used for a sound source separated from the first content, and a sound source similar to the tempo or rhythm of the sound source separated from the first content to the creator 20.

Specifically, the generation unit 133 presents the sound sources to the creator 20 in order of at least one of those corresponding to the following elements: those having a closer reproduction time to the sound source separated from the first content; those having a closer pitch to the sound source separated from the first content; or those having a closer tone to the sound source separated from the first content, among the plurality of similar sound sources. The creator 20 can find a similar sound source desired by the creator from similar sound sources listed in the window 347 illustrated in FIG. 8.

In addition, the generation unit 133 may present, to the creator 20, similar sound sources in order from those corresponding to any element such as those used more often by other users or those whose second content newly produced by using the similar sound source by other users is viewed more often, among the plurality of similar sound sources. As a result, the creator 20 can preferentially find a material popular to other creators or a sound source preferred by users who views the material.

In addition, in a case where the creator 20 uses a sound source separated from the first content or a similar sound source, the generation unit 133 may present, to the creator 20, a similar sound source for which a use condition that puts a lighter load on the creator 20 is set. As described above, in a case where the creator 20 produces music using the first content or the separated sound source, a compensation such as a copyright usage fee is incurred for the use. Therefore, the generation unit 133 may preferentially present, among similar sound sources, a similar sound source set at a lower compensation or a similar sound source with a looser use condition (there is no restriction on the reproduction time, there is no restriction on the use part, and the like) to the creator 20. As a result, the creator 20 can produce music using the sound source desired by himself/herself while suppressing the usage fee to be paid.

Note that, when generating the separated sound source, the generation unit 133 generates the right information of the sound source separated from the first content on the basis of the right information assigned to the first content in advance. For example, in a case where the use condition and the permission information for secondary use are included in the first content, the generation unit 133 succeeds the information to the right information of the sound source separated from the first content. As a result, even if a new music is produced using a part of the first content as a material, the right holder of the first content can receive the distribution of the usage fee according to the use of the new music, and can track in what kind of new music the own sound source is used.

In a case where the second content is produced by partially using the first content, the assignment unit 134 assigns the right information related to the second content on the basis of the right information acquired by the acquisition unit 131.

For example, the assignment unit 134 assigns, as the right information of the second content, information indicating that production of the second content using the first content has been permitted. As a result, the creator 20 can prove that the produced second content is produced using the first content for which the secondary use is permitted.

In addition, in a case where the second content is produced, the assignment unit 134 may assign information indicating that an agreement has been obtained from a plurality of right holders who permit the secondary use of the first content. In a case where a plurality of copyright holders exists for the first content, when the first content is secondarily used, permission of a set number of copyright holders (for example, all copyright holders) may be required. In this case, in a case where information indicating that an agreement has been obtained from a plurality of right holders is set as the right information of the first content, the assignment unit 134 assigns the information as the right information of the second content. As a result, the creator 20 can prove that the second content is produced using the first content for which use is permitted on the basis of the agreement.

Furthermore, in a case where information regarding a permission and a use condition regarding the distribution of the content produced by secondary use is assigned to the first content, the assignment unit 134 may assign information indicating that the distribution of the second content is permitted, as the right information regarding the second content. As a result, in a case where the creator 20 desires to distribute the second content, the creator can distribute the second content without obtaining permission for distribution from the right holder of the first content again. Note that, in a case where the second content is distributed on the basis of the information set in the first content, the assignment unit 134 may also assign, to the second content, information such as a usage fee to be distributed to the right holder of the first content that is the material.

Further, the assignment unit 134 assigns, as the right information related to the second content, information of the right holder having the copyright related to the first content together with the right holder having the copyright related to the second content. In this case, as illustrated in FIG. 11 and the like, the creator 20 who has produced the second content registers the copyright information regarding the second content.

Furthermore, on the basis of the right information assigned by the assignment unit 134, the acquisition unit 131 may search for other existing music to be recommended to the creator 20 or a sound source to be a material.

For example, the acquisition unit 131 may refer to the right information assigned to the first content in advance, and acquire another first content to which an advantageous use condition is assigned compared with the use condition indicated in the right information.

Specifically, the acquisition unit 131 refers to information regarding a usage fee in a case where the second content is produced by partially using the first content as the right information assigned to the first content in advance, and acquires another first content to which a usage fee lower than the usage fee is assigned. As a result, the creator 20 can find existing music and sound sources that can be used at a lower price.

In addition, the acquisition unit 131 may refer to history information in which the first content has been used when the music has been produced in the past, and acquire another first content to which history information indicating more use histories has been assigned. That is, the acquisition unit 131 may acquire highly popular first content used by more creators and present the first content to the creator 20 as a recommendation.

In addition, in a case of acquiring the right information assigned to the first content in advance during the production of the second content, the acquisition unit 131 may display a list of the right information assigned to the first content in advance on the user interface that controls the production of the second content. For example, the acquisition unit 131 displays the window 351 illustrated in FIG. 9 on the DAW, and displays the acquired right information so as to be browsable by the creator 20.

Specifically, in a case where the second content is produced by partially using the first content, the acquisition unit 131 displays, on the user interface, a usage fee paid by the producer of the second content to the right holder of the first content. As a result, the creator 20 can confirm at a glance what kind of first content is included as a material in the second content that the creator intends to produce and how much usage fee will be generated.

In addition, the acquisition unit 131 may display, as the usage fee, a time during which the first content is used in the second content or a usage fee individually set for each configuration of the first content. For example, the acquisition unit 131 acquires the copyright rate and the initial cost set for each piece of the first content as in the window 351 illustrated in FIG. 9, and displays the acquired information. As a result, the creator 20 can proceed with production while confirming how much the usage fee is generated in a case where which first content is used for how long.

In addition, the assignment unit 134 may assign, as the right information related to the second content, information indicating whether or not to permit the secondary use of producing third content which is new content by partially using the second content. As described above, the permission information related to the second content is set by the creator 20 and registered on the DAW. The information is assigned to the second content by the assignment unit 134 and registered in the information management system 50 (blockchain). At this time, the creator 20 can set a permission condition when the second content of which the creator is the right holder is secondarily used. Thus, in a case where the second content produced by the creator 20 is used by a third party, the creator can obtain distribution based on the use.

As illustrated in FIG. 11 and the like, the assignment unit 134 provides a use condition including a time during which the second content is used in the third content or a usage fee individually set for each configuration of the second content.

In addition, in response to a request from the author (creator 20 or a person to whom copyright is entrusted by creator 20) of the second content, the assignment unit 134 may distribute the second content to which the information indicating whether or not the secondary use of the second content is permitted and the use condition are assigned. Specifically, the assignment unit 134 can distribute the second content by entrusting the distribution of the second content to the distribution intermediary 30. For example, by registering, in the information management system 50, that the author desires to distribute the second content, the assignment unit 134 can start distribution by the distribution intermediary 30 that has received such information.

In this manner, the assignment unit 134 registers the right information related to the second content in the ledger data of the blockchain configured with at least one of the distributor of the second content (the distribution intermediary 30), the manager of the right information assigned to the second content (the music publishing company 35), or the collector of usage fees in a case where the second content is used (the copyright manager 40).

Since it is difficult to tamper data due to the structure of the blockchain, the assignment unit 134 can safely hold the right information regarding the second content and the like.

### 1-5. Procedure of Information Processing According to Embodiment

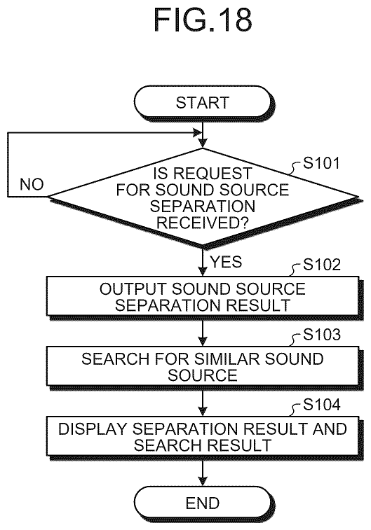

Next, a procedure of information processing according to the embodiment will be described with reference to FIGS. 18 to 20. First, a flow of sound source separation processing according to the embodiment of the present disclosure will be described with reference to FIG. 18. FIG. 18 is a flowchart (1) illustrating a procedure of information processing according to the embodiment.

As illustrated in FIG. 18, the information processing apparatus 100 determines whether or not a request for sound source separation has been received from the creator 20 (Step S101). In a case where the request has not been received (Step S101; No), the information processing apparatus 100 waits until receiving the request.

On the other hand, in a case where the request has been received (Step S101; Yes), the information processing apparatus 100 outputs the sound source separation result (Step S102).

Subsequently, the information processing apparatus 100 searches for a similar sound source similar to the separated sound source (Step S103). Then, the information processing apparatus 100 displays the separation result and the search result on the user interface of the DAW (Step S104).

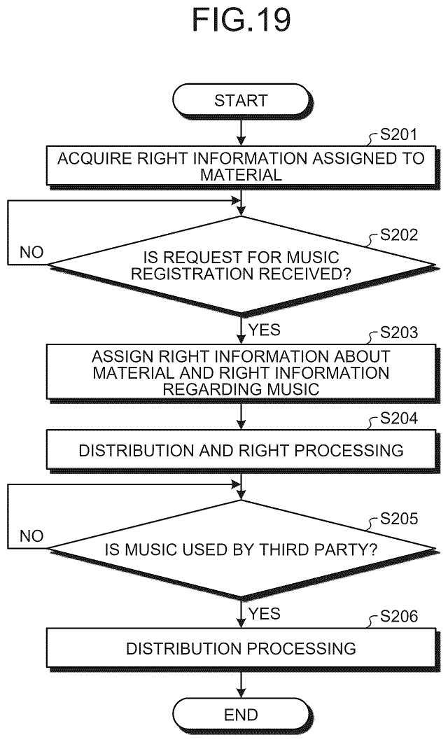

Next, a flow of right information assignment according to the embodiment of the present disclosure will be described with reference to FIG. 19. FIG. 19 is a flowchart (2) illustrating a procedure of information processing according to the embodiment.

As illustrated in FIG. 19, the information processing apparatus 100 acquires right information assigned to a material of new music (Step S201). Thereafter, the information processing apparatus 100 determines whether or not a request for music registration is received from the creator 20 who has produced the new music (Step S202). In a case where the request has not been received (Step S202; No), the information processing apparatus 100 waits until receiving the request.

On the other hand, in a case where the request has been received (Step S202; Yes), the information processing apparatus 100 assigns the right information regarding the material and the right information regarding the music set by the creator 20 to the music (Step S203). Note that, in a case where music is produced on the basis of a plurality of materials, the information processing apparatus 100 may assign the right information of all the materials to new music.

Thereafter, the information processing apparatus 100 executes new music distribution and right processing (Step S204). For example, the information processing apparatus 100 executes processing of transmitting a sound source to the distribution intermediary 30, transferring a copyright to the music publishing company 35, and the like.

Thereafter, the information processing apparatus 100 determines whether or not the music is used by a third party (Step S205). In a case where the information is not used by a third party (Step S205; No), the information processing apparatus 100 waits until being used by a third party.

On the other hand, in a case where the music is used by the third party (Step S205; Yes), the information processing apparatus 100 executes distribution processing of the copyright usage fee and the like on the basis of the usage and the right information set in the music (Step S206).

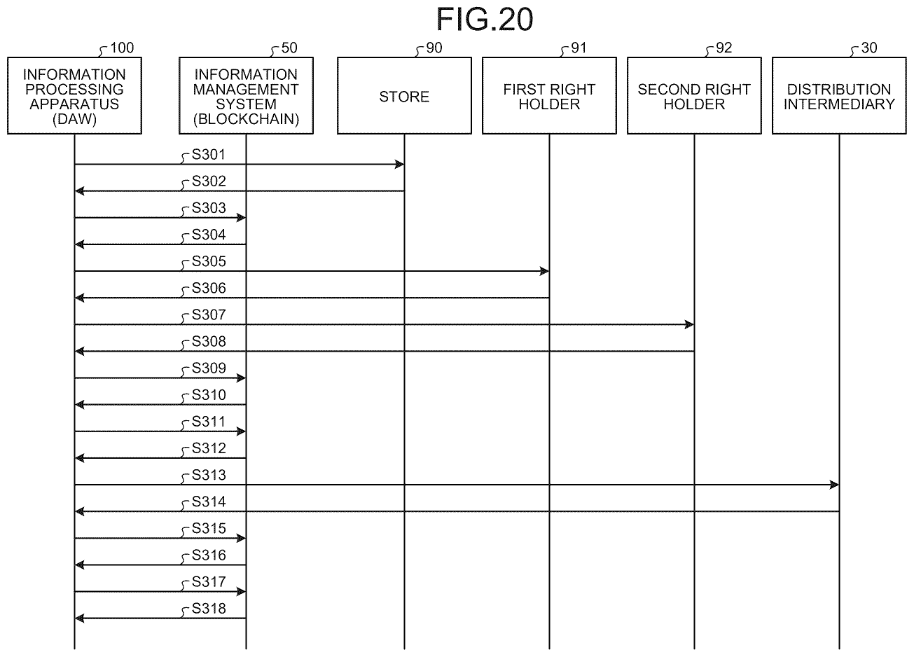

Next, a flow of right processing by the information processing system 1 according to the embodiment will be described with reference to FIG. 20. FIG. 20 is a sequence diagram illustrating a procedure of the information processing system 1 according to the embodiment. FIG. 20 illustrates an example in which, when new music is produced, two right holders (first right holder 91 and second right holder 92) are present in a sound source that is a material of the new music.

In the example illustrated in FIG. 20, the information processing apparatus 100 (that is, the DAW) searches a store 90 for a material desired by the creator 20 according to the operation by the creator 20 (Step S301). The store 90 transmits the search result to the information processing apparatus 100 (Step S302). The information processing apparatus 100 displays the search result on the DAW, and acquires the sound source from the store 90 in response to the purchase request of the creator 20.

Subsequently, the information processing apparatus 100 accesses the information management system 50 and refers to the acquired metadata of the sound source (Step S303). For example, the information processing apparatus 100 inquires about information such as whether the secondary use of the sound source is permitted and what the use condition is. Furthermore, the information processing apparatus 100 refers to the metadata and acquires information regarding the right holder such as the copyright holder registered in the sound source (Step S304).

In a case where the music is produced using the sound source acquired in Step S302, the information processing apparatus 100 accesses the first right holder 91 who is the right holder of the sound source, and transmits the information regarding the music usage contract (Step S305). Such processing is executed by the DAW, for example, when the button 366 illustrated in FIG. 11 is clicked by the creator 20.

For example, the information processing apparatus 100 transmits, to the first right holder 91, information such as use of a sound source for new music, a use time, a use mode, a used part, and the like. In a case where the first right holder 91 determines that the use is made according to the use condition, the first right holder 91 transmits the music usage agreement to the information processing apparatus 100 (Step S306). Note that the first right holder 91 may perform setting in advance so as to automatically return the information regarding the agreement in a case where the information processing apparatus 100 determines that the use is in accordance with the use condition without artificially transmitting the information regarding the agreement.

Similarly to Step S305, the information processing apparatus 100 sends the information regarding the music usage contract to the second right holder 92 (Step S307). The second right holder 92 refers to the music usage contract and transmits the agreement on the music usage to the information processing apparatus 100 (Step S308). Note that, in a case where there are more right holders related to the sound source, the information processing apparatus 100 repeats the processing of Steps S307 and S308 by the number of right holders.

In a case where all right holders have reached an agreement, the information processing apparatus 100 registers the fact that the contract has been agreed in the information management system 50 (Step S309). In a case where the information is approved on the blockchain, the information management system 50 transmits the approval to the information processing apparatus 100 (Step S310). Such information is written in, for example, the metadata of the sound source acquired in Step S302 and the metadata of the new music to be registered subsequently.

Subsequently, the information processing apparatus 100 registers newly produced music to which the right holder, the use condition, and the like are assigned in the information management system 50 (Step S311). In a case where the information is approved on the blockchain, the information management system 50 transmits the approval to the information processing apparatus 100 (Step S312).

Thereafter, the information processing apparatus 100 entrusts the distribution intermediary 30 to distribute the music in response to the request of the creator 20 (Step S313). Note that the information processing apparatus 100 may perform processing such as transferring the right to the music publishing company 35 in parallel with Step S313. The distribution intermediary 30 transmits the fact that the distribution contract is agreed to the information processing apparatus 100 (Step S314).

Thereafter, the information processing apparatus 100 registers information regarding the distribution contract agreement including the right information of the distribution intermediary 30 or the like that has obtained the right to distribute the music in the information management system 50 (Step S315). In a case where the information is approved on the blockchain, the information management system 50 transmits the approval to the information processing apparatus 100 (Step S316).

Thereafter, when there is an inquiry about the music (for example, an inquiry about a usage status, a distribution status, and a reward status) from the creator 20 or the like, the information processing apparatus 100 refers to the music information corresponding to the inquiry in the information management system 50 (Step S317). When acquiring the information corresponding to the inquiry from the information management system 50, the information processing apparatus 100 displays the information on the DAW (Step S318).

As described above, according to the information processing system 1, the creator 20 can browse the information of his/her own music on the DAW at any time even after the music distribution contract or the like. As a result, the creator 20 can confirm integrated information on the right information and the reward information which are likely to be distributed in music distribution on the DAW, and can easily update the contract and management information.

### 1-6. Modifications of Embodiments

### 1-6-1. Operation as Information Processing System

In the above embodiments, an example in which the information processing according to the present disclosure is executed by the information processing apparatus 100 has been described. However, the information processing according to the present disclosure may be executed by cooperation of the creator terminal 10 which is a local terminal, the distribution intermediary 30, and the like. That is, the information processing according to the present disclosure is not limited to those exemplified in the embodiments, and may be executed on the information processing system 1 including various apparatuses.

### 1-6-2. Right Information

In the above embodiments, as the right information, an example has been described in which information regarding a copyright of music, permission of secondary use of music, a use condition, and the like is recorded as metadata. However, the right information is not limited thereto.

For example, the right information may include information of not only a lyricist and a composer of music but also an arranger, a person to whom a copyright is transferred, a performer, a person having neighboring rights of an author, and the like. In addition, the right information may include setting of a share and a reward amount of each right holder, consensus information (agreement information) indicating an agreement of each right holder regarding the share, a contract content and a message when the agreement is obtained, a contact address of each right holder, and the like. Further, the metadata of the music may include each right information about all sound sources incorporated as materials in the music.

Furthermore, the right information may include a digital signature or the like indicating that the creator 20, the distribution intermediary, or the like has agreed to the distribution contract or the transfer of the right. In addition, the right information may include an amount of distribution such as how much amount of money is distributed per distribution, a ratio of a reward amount distributed to each right holder, a share of a copyright usage fee of each copyright holder, and the like.

Furthermore, in the above embodiments, an example has been described in which the use permission of the sound source used for the new music is automatically executed using the smart contract. In this case, the information processing apparatus 100 may not necessarily receive permission from all the copyright holders, and may proceed the automatic contract according to individual conditions set in each piece of right information, such as “use of the sound source is allowed in a case where some percentage of the entire copyright holders have permitted”. In this manner, the information processing apparatus 100 can improve the efficiency of music production and subsequent distribution processing by flexibly and quickly executing use permission and the like.

### 1-6-3. Production System

In the above embodiments, an example has been described in which production of music is executed on the creator terminal 10 operated by the creator 20. However, the music may be simultaneously produced in parallel by a plurality of terminal apparatuses operated by a plurality of creators.

As described above, by providing the DAW as a cloud application, the information processing apparatus 100 can share files on which a plurality of creators work in the cloud. Thus, the plurality of creators can produce music while operating one work file in parallel.

In addition, the information processing apparatus 100 acquires the right information of the material included in the file being produced in real time and displays the right information on the DAW. For this reason, the plurality of creators can proceed with the production while constantly checking what kind of material is included as the material being produced, how much cost is generated, or the like.

### 2. Other Embodiments

The processing according to each embodiment described above may be performed in various different modes other than each embodiment described above.

For example, among the processes described in the above embodiments, all or part of the processes described as being performed automatically can be performed manually, or all or part of the processes described as being performed manually can be performed automatically by a known method. In addition, the processing procedure, specific name, and information including various data and parameters illustrated in the document and the drawings can be arbitrarily changed unless otherwise specified. For example, the various types of information illustrated in each figure are not limited to the illustrated information.

In addition, each component of each apparatus illustrated in the drawings is functionally conceptual, and is not necessarily physically configured as illustrated in the drawings. That is, a specific form of distribution and integration of each apparatus is not limited to the illustrated form, and all or a part thereof can be functionally or physically distributed and integrated in an arbitrary unit according to various loads, usage conditions, and the like.

In addition, the above-described embodiments and modifications can be appropriately combined within a range in which the processing contents do not contradict each other.

Furthermore, the effects described in the present specification are merely examples and are not limited, and other effects may be provided.

### 3. Effects of Information Processing Apparatus According to Present Disclosure

As described above, the information processing apparatus (the information processing apparatus 100 in the embodiment) according to the present disclosure includes the acquisition unit (the acquisition unit 131 in the embodiment), the reception unit (the reception unit 132 in the embodiment), the generation unit (the generation unit 133 in the embodiment), and the assignment unit (the assignment unit 134 in the embodiment).

The acquisition unit acquires the first content. The reception unit receives a request for separating the first content acquired by the acquisition unit into a plurality of sound sources from the user of the DAW (the creator 20 in the embodiment). On the basis of the request received by the reception unit, the generation unit generates the sound source separated from the first content in a format that can be used on the DAW by inputting the first content to the model in which the feature of each sound source constituting the music is learned in advance.

As described above, the information processing apparatus can separate the sound source in a format according to the request of the creator and generate sound sources even from the existing music or the like, for example, in a format that can be used in the DAW. Therefore, it is possible to improve the efficiency of music production in recent years in which sampling materials and the like are frequently used.

Furthermore, the generation unit inputs the first content to a model in which the feature of each musical instrument constituting the music is learned in advance, thereby generating the sound source of each musical instrument separated from the first content in a format that can be used on the DAW.

As described above, since the information processing apparatus can separate the sound source for each musical instrument, it is possible to appropriately provide the sound source desired by the creator in music production.

Furthermore, after generating the sound source separated from the first content, the generation unit presents a similar sound source that is a sound source similar to the sound source to the user.

As described above, by presenting not only the separated sound source but also the similar sound source, the information processing apparatus can provide a sound source similar to the sound source desired by the creator to the creator and support the music production.

Furthermore, the generation unit presents, as the similar sound source, a musical instrument used for the sound source separated from the first content and a sound source similar to the tempo or rhythm of the sound source separated from the first content to the user.

In this manner, the information processing apparatus can efficiently search for the sound source desired by the creator by determining the similarity on the basis of the musical instrument (that is, the tone), the tempo, and the like.

In addition, the generation unit presents the sound sources to the user in order of at least one of those corresponding to the following elements: those having a closer reproduction time to the sound source separated from the first content; those having a closer pitch to the sound source separated from the first content; or those having a closer tone to the sound source separated from the first content, among the plurality of similar sound sources.

As described above, the information processing apparatus presents the searched similar sound sources as a list to the creator, thereby increasing the options of the creator and encouraging more active music production.

In addition, the generation unit presents, to the user, similar sound sources in order from those corresponding to any element such as those used more often by other users or those whose second content newly produced by using the similar sound source by other users is viewed more often, among the plurality of similar sound sources.

As described above, the information processing apparatus presents the similar sound source according to the popularity of the sound source, so that it is possible to provide the creator with information including what sound source is accepted by many users.

In addition, the acquisition unit acquires a use condition assigned in advance to the first content. In a case where the user uses the sound source separated from the first content or the similar sound source, the generation unit presents, to the user, the similar sound source in which a use condition that puts a lighter load on the user is set.

As described above, the information processing apparatus can preferentially provide a sound source that does not impose a load on the creator by presenting a similar sound source according to a condition (permission, copyright usage fee, or the like) when the creator uses the first content for the music, and thus, it is possible to encourage the creator to produce the music.

In addition, the reception unit calculates a compensation borne by the user in order to execute the processing of separating the first content into a plurality of sound sources, presents the calculated compensation to the user, and receives a request for separating the first content into the plurality of sound sources from the user.

In this manner, the information processing apparatus can promote monetization in music production using the DAW by receiving sound source separation after indicating a compensation such as points.

In addition, the acquisition unit acquires the right information assigned to the first content in advance. The generation unit generates the right information of the sound source separated from the first content on the basis of the right information assigned to the first content in advance.

As described above, the information processing apparatus can prevent the first content from being unreasonably used or the right holder of the first content from not receiving a fair reward by taking over the right information assigned to the first content even for the separated sound source.

In addition, the reception unit receives a request for separating a part of the first content from the user. The generation unit generates a sound source separated from a part of the first content by inputting the part to the model.

In this manner, the information processing apparatus can quickly perform the separation processing by separating only a part of the sound source.

In addition, the acquisition unit acquires the right information assigned to the first content in advance. In a case where the second content (in the embodiment, new music produced by the creator 20) is produced by partially using the first content, the assignment unit assigns the right information related to the second content on the basis of the right information acquired by the acquisition unit.

In this manner, the information processing apparatus assigns appropriate right information to the second content produced using, for example, the sampling material on the basis of the right information of the first content. As a result, the information processing apparatus can prevent an error in right setting due to manual input or the like from occurring without bothering the creator of complicated right processing, and thus, can efficiently perform music management.

In addition, the acquisition unit acquires information regarding permission and a use condition regarding secondary use set in the first content as the right information assigned in advance to the first content. The assignment unit assigns, as the right information related to the second content, information indicating that production of the second content using the first content has been permitted.

As described above, the information processing apparatus can easily set the right information of the second content while distributing an appropriate reward to the right holder of the first content by handing over the permission information of the secondary use of the first content to the second content.

In addition, the acquisition unit acquires information regarding a plurality of right holders who permit the secondary use of the first content as the right information assigned in advance to the first content. In a case where the second content is produced, the assignment unit assigns information indicating that an agreement has been obtained from a plurality of right holders who permits the secondary use of the first content.

As described above, the information processing apparatus can prove that the second content is the content produced through the proper procedure by assigning the agreement information of the plurality of right holders as the right information.

In addition, the acquisition unit acquires, as the right information assigned in advance to the first content, information regarding permission and a use condition regarding distribution of the content produced by secondarily using the first content. The assignment unit assigns information indicating that the distribution of the second content is permitted as the right information related to the second content.

As described above, the information processing apparatus can efficiently perform processing of distributing the profit when the second content is distributed to the right holder of the first content or the like by taking over the information regarding the distribution of the first content.

In addition, the acquisition unit acquires, as the right information assigned in advance to the first content, information on the right holder who has the copyright related to the first content. The assignment unit assigns, as the right information related to the second content, information of the right holder who holds the copyright related to the first content together with the right holder who holds the copyright related to the second content.

As described above, by including the copyright holder information of the first content in the second content, the information processing apparatus can efficiently perform processing of notifying the right holder that the first content has been used for producing another piece of music, distribution processing of the copyright usage fee, and the like.

In addition, the acquisition unit refers to the right information assigned in advance to the first content, and acquires another first content to which an advantageous use condition is assigned compared with the use condition indicated in the right information.

As described above, since the information processing apparatus can recommend a material that can be used under more advantageous conditions to the creator who intends to use the first content, it is possible to stimulate music production by the creator.

In addition, the acquisition unit refers to information regarding a usage fee in a case where the second content is produced by partially using the first content as the right information assigned in advance to the first content, and obtains another first content to which a usage fee lower than the usage fee is assigned.

In this manner, the information processing apparatus can stimulate music production by the creator by recommending a material to which a lower usage fee is set.

In addition, the acquisition unit refers to history information in which the first content has been used when the second content has been produced in the past, and acquires another first content to which history information indicating a larger number of use histories has been assigned.

In this manner, the information processing apparatus can promote music production assumed to be accepted by more users by recommending a material according to a history in which the material is used, in other words, popularity.

In addition, in a case where the acquisition unit acquires the right information assigned to the first content in advance during the production of the second content, the acquisition unit displays a list of the right information assigned to the first content in advance on the user interface that controls the production of the second content.

In this manner, the information processing apparatus can provide the creator with information such as what kind of material is used to produce music in real time by displaying the right information on the window of the DAW, for example.

In addition, in a case where the second content is produced by partially using the first content, the acquisition unit displays, on the user interface, a usage fee paid by the producer of the second content to the right holder of the first content.

As described above, the information processing apparatus can cause the creator to recognize in advance the usage fee of the material that is a concern by displaying the cost required in a case where the music is produced in real time.

In addition, the acquisition unit displays, as the usage fee, a time during which the first content is used in the second content or a usage fee individually set for each configuration of the first content.

In this manner, the information processing apparatus can notify the creator of the cost related to music production in real time by displaying, on the DAW, which material is used and how much the usage fee is generated.

In addition, the assignment unit assigns, as the right information related to the second content, information indicating whether or not to permit secondary use of producing the third content that is new content by partially using the second content.

As described above, the information processing apparatus can easily set the right information, which conventionally takes time and effort of the creator, by assigning the right information to the second content.

In addition, the assignment unit assigns a use condition including a time during which the second content is used in the third content or a usage fee individually set for each configuration of the second content.

In this manner, the information processing apparatus can distribute an appropriate usage fee to the right holder of the second content in a case where the second content is used by assigning the condition regarding the use of the second content. As a result, the information processing apparatus can give an incentive for the creator to produce music.

Further, the acquisition unit acquires a distribution request of the second content from the copyright holder of the second content. In response to the distribution request acquired by the acquisition unit, the assignment unit distributes the second content to which the information indicating whether or not the secondary use of the second content is permitted and the use condition are assigned.

As described above, the information processing apparatus receives the distribution request via the DAW or the like, so that it is possible to easily perform the distribution setting which conventionally requires time and effort of the creator.

Further, the assignment unit registers the right information related to the second content in the ledger data of the blockchain configured with at least one of the distributor of the second content, the manager of the right information assigned to the second content, or the collector of the usage fee in a case where the second content is used.

As described above, by registering the right information using the blockchain, the information processing apparatus can prevent data tampering and improve convenience for various entities to access or update the right information.

### 4. Hardware Configuration

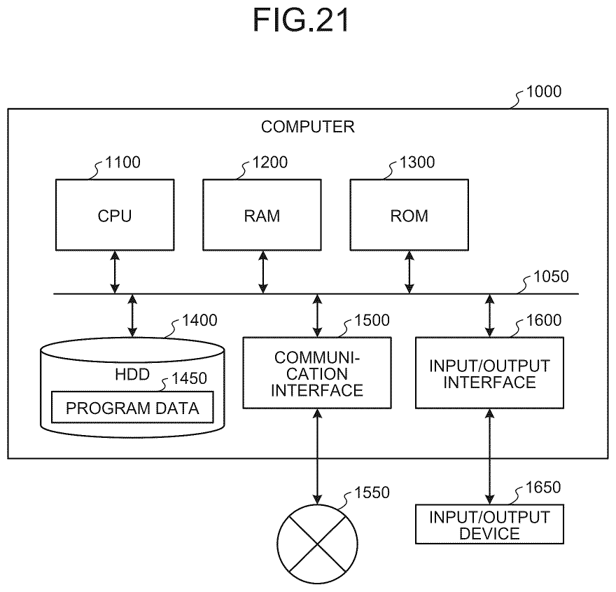

The information device such as the information processing apparatus 100 according to each embodiment described above is implemented by a computer 1000 having a configuration as illustrated in FIG. 21, for example. Hereinafter, the information processing apparatus 100 according to the embodiment will be described as an example. FIG. 21 is a hardware configuration diagram illustrating an example of the computer 1000 that implements the functions of the information processing apparatus 100. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records a program executed by the CPU 1100, data used by the program, and the like. Specifically, the HDD 1400 is a recording medium that records an information processing program according to the present disclosure as an example of the program data 1450.

The communication interface 1500 is an interface for the computer 1000 to connect to an external network 1550 (for example, the Internet). For example, the CPU 1100 receives data from another equipment or transmits data generated by the CPU 1100 to another equipment via the communication interface 1500.

The input/output interface 1600 is an interface for connecting a input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing apparatus 100 according to the embodiment, the CPU 1100 of the computer 1000 implements the functions of the control unit 130 and the like by executing the information processing program loaded on the RAM 1200. In addition, the HDD 1400 stores an information processing program according to the present disclosure and data in the storage unit 120. Note that the CPU 1100 reads the program data 1450 from the HDD 1400 and executes the program data, but as another example, these programs may be acquired from another apparatus via the external network 1550.

Note that the present technology can also have the following configurations.
(1) An information processing apparatus comprising:
   an acquisition unit that acquires first content;
   a reception unit that receives, from a user, a request for separating the first content acquired by the acquisition unit into a plurality of sound sources; and
   a generation unit that generates a sound source separated from the first content in a format that can be used on a digital audio workstation (DAW) by inputting the first content to a model in which a feature of each sound source constituting music is learned in advance on the basis of the request received by the reception unit.
(2) The information processing apparatus according to (1), wherein
   the generation unit is configured to
   generate a sound source of each musical instrument separated from the first content in a format that can be used on the DAW by inputting the first content to the model in which a feature of each musical instrument constituting the music is learned in advance.
(3) The information processing apparatus according to (1) or (2), wherein
   the generation unit is configured to,
   after generating the sound source separated from the first content, present a similar sound source that is a sound source similar to the sound source to the user.
(4) The information processing apparatus according to (3), wherein
   the generation unit is configured to
   present, as the similar sound source, a musical instrument used for the sound source separated from the first content and a sound source similar to a tempo or a rhythm of the sound source separated from the first content to the user.
(5) The information processing apparatus according to (3) or (4), wherein
   the generation unit is configured to
   present the sound source to the user in order of at least one of those corresponding to following elements: those having a closer reproduction time to the sound source separated from the first content; those having a closer pitch to the sound source separated from the first content; or those having a closer tone to the sound source separated from the first content, among a plurality of the similar sound source.
(6) The information processing apparatus according to (3) or (4), wherein
   the generation unit is configured to
   present the sound source to the user in order from those corresponding to any element such as those used more often by other users or those whose second content newly produced by using the similar sound source by other users is viewed more often, among a plurality of the similar sound source.
(7) The information processing apparatus according to any one of (3) to (6), wherein
   the acquisition unit is configured to
   acquire a use condition assigned in advance to the first content, and
   the generation unit is configured to,
   in a case where the user uses the sound source separated from the first content or the similar sound source, present a similar sound source in which a use condition that puts a lighter load on the user is set to the user.
(8) The information processing apparatus according to any one of (1) to (7), wherein
   the reception unit is configured to
   calculate a compensation borne by the user to execute processing of separating the first content into the plurality of sound sources, present the compensation calculated to the user, and then receive, from the user, the request for separating the first content into the plurality of sound sources.
(9) The information processing apparatus according to any one of (1) to (8), wherein
   the acquisition unit is configured to
   acquire right information assigned in advance to the first content, and
   the generation unit is configured to
   generate right information of the sound source separated from the first content on the basis of the right information assigned in advance to the first content.
(10) The information processing apparatus according to any one of (1) to (9), wherein
   the reception unit is configured to
   receive a request for separating a part of the first content from the user, and
   the generation unit is configured to
   input the part of the first content into the model to generate a sound source separated from the part.
(11) An information processing method, by a computer, comprising:
   acquiring first content;
   receiving, from a user, a request for separating the first content acquired into a plurality of sound sources; and
   generating a sound source separated from the first content in a format that can be used on a digital audio workstation (DAW) by inputting the first content to a model in which a feature of each sound source constituting music is learned in advance on the basis of the request.
(12) An information processing program for causing a computer to function as:
   an acquisition unit that acquires first content;
   a reception unit that receives, from a user, a request for separating the first content acquired by the acquisition unit into a plurality of sound sources; and
   a generation unit that generates a sound source separated from the first content in a format that can be used on a digital audio workstation (DAW) by inputting the first content to a model in which a feature of each sound source constituting music is learned in advance on the basis of the request received by the reception unit.

### REFERENCE SIGNS LIST

1 INFORMATION PROCESSING SYSTEM
10 CREATOR TERMINAL
20 CREATOR
30 DISTRIBUTION INTERMEDIARY
35 MUSIC PUBLISHING COMPANY
40 COPYRIGHT MANAGER
50 INFORMATION MANAGEMENT SYSTEM
100 INFORMATION PROCESSING APPARATUS
110 COMMUNICATION UNIT
120 STORAGE UNIT
121 CREATOR STORAGE UNIT
122 SOUND SOURCE STORAGE UNIT
130 CONTROL UNIT
131 ACQUISITION UNIT
132 RECEPTION UNIT
133 GENERATION UNIT
134 ASSIGNMENT UNIT
200 USER TERMINAL

1. An information processing apparatus comprising:
an acquisition unit that acquires first content;
a reception unit that receives, from a user, a request for separating the first content acquired by the acquisition unit into a plurality of sound sources; and
a generation unit that generates a sound source separated from the first content in a format that can be used on a digital audio workstation (DAW) by inputting the first content to a model in which a feature of each sound source constituting music is learned in advance on the basis of the request received by the reception unit.

2. The information processing apparatus according to claim 1, wherein
the generation unit is configured to
generate a sound source of each musical instrument separated from the first content in a format that can be used on the DAW by inputting the first content to the model in which a feature of each musical instrument constituting the music is learned in advance.

3. The information processing apparatus according to claim 1, wherein
the generation unit is configured to,
after generating the sound source separated from the first content, present a similar sound source that is a sound source similar to the sound source to the user.

4. The information processing apparatus according to claim 3, wherein
the generation unit is configured to
present, as the similar sound source, a musical instrument used for the sound source separated from the first content and a sound source similar to a tempo or a rhythm of the sound source separated from the first content to the user.

5. The information processing apparatus according to claim 3, wherein
the generation unit is configured to
present the sound source to the user in order of at least one of those corresponding to following elements: those having a closer reproduction time to the sound source separated from the first content; those having a closer pitch to the sound source separated from the first content; or those having a closer tone to the sound source separated from the first content, among a plurality of the similar sound source.

6. The information processing apparatus according to claim 3, wherein
the generation unit is configured to
present the sound source to the user in order from those corresponding to any element such as those used more often by other users or those whose second content newly produced by using the similar sound source by other users is viewed more often, among a plurality of the similar sound source.

7. The information processing apparatus according to claim 3, wherein
the acquisition unit is configured to
acquire a use condition assigned in advance to the first content, and
the generation unit is configured to,
in a case where the user uses the sound source separated from the first content or the similar sound source, present a similar sound source in which a use condition that puts a lighter load on the user is set to the user.

8. The information processing apparatus according to claim 1, wherein
the reception unit is configured to
calculate a compensation borne by the user to execute processing of separating the first content into the plurality of sound sources, present the compensation calculated to the user, and then receive, from the user, the request for separating the first content into the plurality of sound sources.

9. The information processing apparatus according to claim 1, wherein
the acquisition unit is configured to
acquire right information assigned in advance to the first content, and
the generation unit is configured to
generate right information of the sound source separated from the first content on the basis of the right information assigned in advance to the first content.

10. The information processing apparatus according to claim 1, wherein
the reception unit is configured to
receive a request for separating a part of the first content from the user, and
the generation unit is configured to
input the part of the first content into the model to generate a sound source separated from the part.

11. An information processing method, by a computer, comprising:
acquiring first content;
receiving, from a user, a request for separating the first content acquired into a plurality of sound sources; and
generating a sound source separated from the first content in a format that can be used on a digital audio workstation (DAW) by inputting the first content to a model in which a feature of each sound source constituting music is learned in advance on the basis of the request.

12. An information processing program for causing a computer to function as:
an acquisition unit that acquires first content;
a reception unit that receives, from a user, a request for separating the first content acquired by the acquisition unit into a plurality of sound sources; and
a generation unit that generates a sound source separated from the first content in a format that can be used on a digital audio workstation (DAW) by inputting the first content to a model in which a feature of each sound source constituting music is learned in advance on the basis of the request received by the reception unit.
